(19) United States
(12) Patent Application Publication
(10) Pub. No.: US 2014/0201642 A1
(43) Pub. Date: Jul. 17, 2014

(54) USER INTERFACE FOR VISUALIZING RESOURCE PERFORMANCE AND MANAGING RESOURCES IN CLOUD OR DISTRIBUTED SYSTEMS

(71) Applicant: Lyatiss, Inc., Mountain View, CA (US)

(72) Inventor: Pascale VICAT-BLANC, San Francisco, CA (US)

(73) Assignee: Lyatiss, Inc., Mountain View, CA (US)

(21) Appl. No.: 14/152,885

(22) Filed: Jan. 10, 2014

Related U.S. Application Data
(60) Provisional application No. 61/751,854, filed on Jan. 12, 2013.

(51) Int. Cl. H04L 12/24; H04L 29/06

(52) U.S. Cl. CPC H04L 41/22; H04L 63/08
USPC 715/736

(57) ABSTRACT

Disclosed are methods and apparatus that allow users and organizations to access on-demand and in a personalized way to the performance and optionally flow activity measures of an end to end network of virtual resources. The system is configured to generate a UI that provides a mapping and characterization of the network of virtual resources. In one embodiment, a network topology map can be generated in the UI. In another embodiment, a flow map including nodes and flows can be generated in the UI. The UI is configured to provide users with a number of actions that can be implemented to affect the virtual resources. The actions can be presented in the user via menu options or actionable objects. The user can implement high-level actions provided by the UI. Upon receipt of a high-level action, the system is configured to translate the action into a sequence of low-level device commands needed to implement the action. The system can communicate with the low-level devices in the cloud to implement the commands.

### CROSS-REFERENCE TO RELATED APPLICATION

This application claims priority of U.S. Provisional Patent Application No. 61/751,854, entitled USER INTERFACE FOR VISUALIZING RESOURCE PERFORMANCE AND MANAGING RESOURCES IN CLOUD NETWORKS, filed 12 Jan. 2013 by Pascale VICAT-BLANC, which application is incorporated herein by reference in its entirety for all purposes.

### TECHNICAL FIELD OF THE INVENTION

The invention relates to the area of managing virtual resources in a cloud or distributed environment. More particularly, the invention is related to a user interface that provides modeling and visualization of end to end network traffic and real-time resource management in the context of virtual or physical networks and in a distributed or cloud environment.

### BACKGROUND

In a cloud or distributed environment, applications are distributed and deployed over virtual resources that are dynamically provisioned and mapped to a pool of physical servers that are allowed to communicate in some manner through some type of physical network. From a customer perspective, the virtual resources are typically virtual machines that execute customer applications. The machines are “virtual” in the sense that 1) the underlying physical servers on which the virtual machines are operating can change over time (migration), 2) a variable number of virtual machines are running on the same physical server, sharing the underlying processor, memory, disk and network interface capabilities (sharing). Using the abstraction of a virtual machine, the changing nature of the physical servers is opaque to customer applications, yet, can cause the applications to experience variable and unpredictable performance.

The customer applications often include components that execute on different virtual machines that need to communicate with one another to complete a particular task. Thus, a virtual network is formed between the virtual machines where the performance of the virtual resources, including both the virtual network and the virtual machines, affects how quickly the particular task is completed within the customer application. The performance of the virtual resources is constantly changing and is difficult to characterize as the underlying physical resources are constantly changing. In addition, for a particular customer application, how the application interacts with the virtual resources affects the perceived performance of the virtual resources from the point of view of the application. This coupling between the application and the resources adds additional complexity to the performance characterization problem.

Every customer utilizing cloud or distributed network resources wants to ensure that their applications are sufficiently optimized to meet the demands of their business at all times while not wasting resources. Currently, resource management tools are very limited or non-existent. In view of the above, new methods and apparatus for application specific cloud or distributed resource management are needed.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A system for allowing users and organizations to access on-demand, and in a personalized way, system and network performance and flow activity measures of an end-to-end network path is described. The system may be configured to generate a user interface (UI) that provides a mapping and characterization of the network of virtual resources. In one embodiment, a network topology map can be generated in the UI. In another embodiment, a flow map including nodes and flows can be generated in the UI. The UI is configured to provide users with a number of actions that can be implemented to affect the virtual resources. The actions can be presented in the user via menu options or actionable objects. The user can implement high-level actions provided by the UI. Upon receipt of a high-level action, the system is configured to translate the action into a sequence of low-level device commands needed to implement the action. The system can communicate with the low-level devices in the cloud to implement the commands.

In one embodiment, a method implemented in at least one electronic device including a processor and a memory is disclosed. In the processor, cloud or distributed resource access credentials for a user is received. In the processor, cloud or distributed resource data is collected using a native resource interface. In the processor, topology data is extracted from the cloud or distributed resource data, and the topology data describes virtual resources of the user in a cloud or distributed resource configuration. Based upon the topology data, a network topology map is generated in the processor. In the processor, output of a User Interface (UI) including the network topology map is controlled, and the UI includes a plurality of user selectable actions for affecting the virtual resources. In the processor, a selection of a first action is received. The action is translated into a series of device level instructions in accordance with requirements of the cloud or distributed resource, and the processor controls communication with one or more specific virtual resources of the user to implement the device level instructions.

In a specific implementation, monitoring software is deployed to one or more virtual or physical devices associated with the user's virtual resources, and at least a portion of the cloud or distributed resource data is collected via the monitoring software. In a further aspect, based upon the cloud or distributed resource data, nodes and flows associated with the user's virtual resources are determined. a flow map that includes a plurality of actionable node or flow objects representing the flows and nodes is generated. The processor further controls output to the UI of the flow map, which includes actionable node and flow objects, which when each is selected cause additional information pertaining to the selected actionable node or flow object's corresponding node or flow to be output to the UI or cause performance of an action for managing the selected actionable node or the flow object's corresponding virtual resource. In a further embodiment, a selection of a first one of the one or more actionable node or flow objects is received and, in response to such selection, the additional information pertaining to the corresponding node or flow is displayed. In yet a further aspect, each flow represents usage of the user's cloud or distributed configuration between two or more of the nodes, and selection of a first flow object is received. In this aspect, the displayed additional information includes one or more congestion or bottleneck metrics about the first flow object's corresponding flow. In an alternative embodiment, the displayed additional information in the UI indicates performance metrics of the selected actionable node or flow object's corresponding virtual resource and the displayed additional information has a selectable mechanism for the user to change a setup of one or more performance alerts for the selected actionable node or flow object's corresponding virtual resource. In another aspect, the flow map, which is displayed in the UI, includes indications of whether each actionable node and flow object's corresponding virtual resource has a congestion or capacity level that has exceeded a predetermined threshold value.

In an alternative embodiment, the network topology map of the UI is hierarchical and includes a representation of the Internet as a root of one or more regional and/or sub-regional networks that each includes one or more of the user's virtual resources. In a further aspect, the network topology map specifies whether each regional and/or sub-regional network and virtual resource is manageable or non-manageable via the UI. In another example, the first action specifies that a selected one of the user's virtual resources is to move from a first group of virtual resources to a second group of virtual resources. In yet another example, the first action specifies adding a network service. In another implementation, the first action specifies filtering the user's virtual resources for display in the network topology map.

In an alternative embodiment, the invention pertains to an apparatus for cloud or distributed computing resource management. The apparatus is formed from one or more electronic devices that are configured to perform one or more of the above described method operations. In another embodiment, the invention pertains to at least one computer readable storage medium having computer program instructions stored thereon that are arranged to perform one or more of the above described operations.

These and other aspects of the invention are described further below with reference to the figures.

### BRIEF DESCRIPTION OF THE DRAWINGS

FIG. 1 shows a flow path abstraction, including a source and a destination, for one embodiment.

FIG. 2 shows a path connecting two resources in accordance with one embodiment.

FIG. 3 is diagrammatic representation of an example system that can provide flow characterization and resource management for customer cloud resources in accordance with one embodiment.

FIG. 4 is a diagrammatic representation of a system providing cloud resource management in accordance with one embodiment.

FIG. 5 is a flow chart illustrating a procedure for generating a user interface (UI) for managing cloud resources in accordance with a specific implementation of the present invention.

FIG. 6 is an example eXecution infrastructure Description Language (VXDL) file portion.

FIG. 7 shows example objects and representative symbols that can be used in a network topology map in accordance with a specific embodiment of the present invention.

FIG. 8 shows a virtual network including some of the objects that are shown in FIG. 7 in accordance with one embodiment of the present invention.

FIG. 9 shows additional details of a manageable network object in accordance with one embodiment of the present invention.

FIG. 10 shows a UI state for configuring groups of nodes in accordance with a specific embodiment.

FIG. 11 shows a representation of a screen shot of the Internet at the root level, a regional network, a sub-network zone, and an end resource in accordance with a specific embodiment.

FIG. 12 shows a UI state, in which a user interaction has caused information associated with a regional network to be displayed in accordance with a specific embodiment.

FIG. 13 shows a UI state, in which the user has interacted with the interface to pull up a series of actions that can be performed on an end resource in accordance with a specific embodiment.

FIG. 14 shows a UI state, in which the user has interacted with the interface to pull up a series of actions that can be performed on an end resource in accordance with a specific embodiment.

FIG. 15 shows a UI state, in which the user has interacted with the interface to add a network service in accordance with a specific embodiment.

FIG. 16 includes a screen shot with an example of one type of filtering protocol being applied in accordance with one embodiment of the present invention.

FIG. 17 a is a screen shot from a user interface (UI) including a heat map in accordance with a specific embodiment.

FIG. 18 is a flow chart illustrating a procedure for managing cloud resources in accordance with another embodiment.

FIG. 19 illustrates a flow map in accordance with one embodiment of the present invention.

FIG. 20 shows a UI state, in which the user has interacted with the UI of FIG. 19 to display a usage analysis for an active end resource in accordance with a specific embodiment.

FIG. 21 shows a UI state, in which the user has interacted with the UI of FIG. 19 to display a usage analysis of an active flow in accordance with a specific embodiment.

FIG. 22 illustrates an automatically structured flow map in accordance with one embodiment.

FIG. 23 illustrates another representation of the application topology is given in the form of an actionable matrix in accordance with another embodiment of the present invention.

FIG. 24 illustrates a more detailed usage analysis associated with a flow map in accordance with an alternative embodiment.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known component or process operations have not been described in detail to not unnecessarily obscure the present invention. While the invention will be described in conjunction with the specific embodiments, it will be understood that it is not intended to limit the invention to the embodiments.

As described above, in the cloud or a distributed network, applications are deployed over virtual resources that are dynamically provisioned and mapped to a pool of physical servers. While this approach simplifies the server infrastructure set up, the reality of application operations is far more complex. Using this server-centric approach to cloud or distributed provisioning, enterprises that rely on the cloud or distributed computers for demanding, dynamic and mission-critical applications, expose themselves to problems including, 1) unpredictable latencies, 2) lack of visibility into resource interactions, 3) inconsistent and bad user experience, 4) disastrous effects of cascading bottlenecks and 5) wasted capacity due to over-provisioning which drives up costs.

DevOps and IT Ops teams take various approaches to resolve infrastructure problems. For example, the teams may launch multiple resources, and shut down the ones having the highest latencies or that are executing on inappropriate hardware. This approach is manual and time consuming. It leaves no opportunity for dynamic and automatic reconfiguration of the cloud or distributed networking to adapt to problems as they arise. Further, this technique involves heterogeneous management tools, many complicated scripts and manual touch points, which have errors of their own, and such errors may exacerbate rather than solve the problems.

As another approach, complicated and numerous dashboards and alarm systems can be used. These dashboards drown a user in raw data and noise and are not intuitive to use. Further, a significant portion of the raw data that is presented is not even useful to characterizing and solving the current problem of interest. Thus, sifting through these alarms and charts and identifying the true actionable information is time consuming and error prone.

In summary, monitoring and troubleshooting applications that have increasingly varying traffic loads across multiple geographies and with complex constraints, based on a “black box network” and multiple management and operations systems, is very challenging. Applications often experience periods of bad performance and downtime while DevOps teams spend their limited time and resources with hands-on operations to continuously adapt to the changing workloads, instance failures and cloud outages. Therefore, DevOps teams need more network infrastructure automation and programmability, which can be manifested as integrated tools, to overcome these challenges.

Software Defined Networking (SDN) defines a new architecture for the “network machine” and is possibly a step in trying to address these issues. SDN decouples the Network Data plane from its Control plane to enable agile virtual networks. However, as described above and in more detail below, there are a host of issues associated with optimizing application performance in the cloud or distributed network that SDN does not directly address. Thus, the flexibility provided by SDN alone can't ensure predictable and high application performance cloud networking nor efficient cloud or distributed network operations.

As described herein, it is believed that tools for characterizing, abstracting and managing a tight coupling between application, cloud or distributed infrastructure and a virtual or physical network, SDN-based or not, can be used to address and fix the problems associated with optimizing application performance. This approach can be referred to as Application Defined Networking (ADN). ADN provides tools for adapting the network and working around problems automatically, thus maintaining business continuity and optimizing resource utilization. Although the following embodiments are described in the context of virtual networks and cloud environments, embodiments of the present invention may be applied to physical networks, distributed environments, and any other types of environments having an operating system (OS), such as Linux and the like.

ADN tools can characterize cloud operations, present characterization data in a manner that provides an intuitive understanding of current cloud performance issues and then generate an interface for presenting and implementing intelligent remedial actions for solving performance problems. As an example, using ADN tools, a user can discover and articulate the cloud network topology and the application topology associated with their particular applications. The tools can be configured to detect and locate the bottlenecks and provide options for working around these bottlenecks in real time. The ADN tools can be configured to enable two-way communication of performance and configuration information between applications and the networked infrastructure to allow applications to be adapted to the network and the network to be adapted to the applications in a cohesive manner.

With respect to the following figures, architecture for defining and characterizing network and infrastructure performance in an ADN environment is described. The architecture includes a number of abstractions that are presented for the purposes of illustration only and are not meant to be limiting as different abstractions can be utilized within the architecture. Although not described in detail herein, the characterization metrics derived from the characterization architecture can be presented in an interface that allows a user to manage and optimize their application performance and resource utilization in a cloud environment. In one embodiment, the characterization metrics can be derived from state variables associated with the TCP protocol.

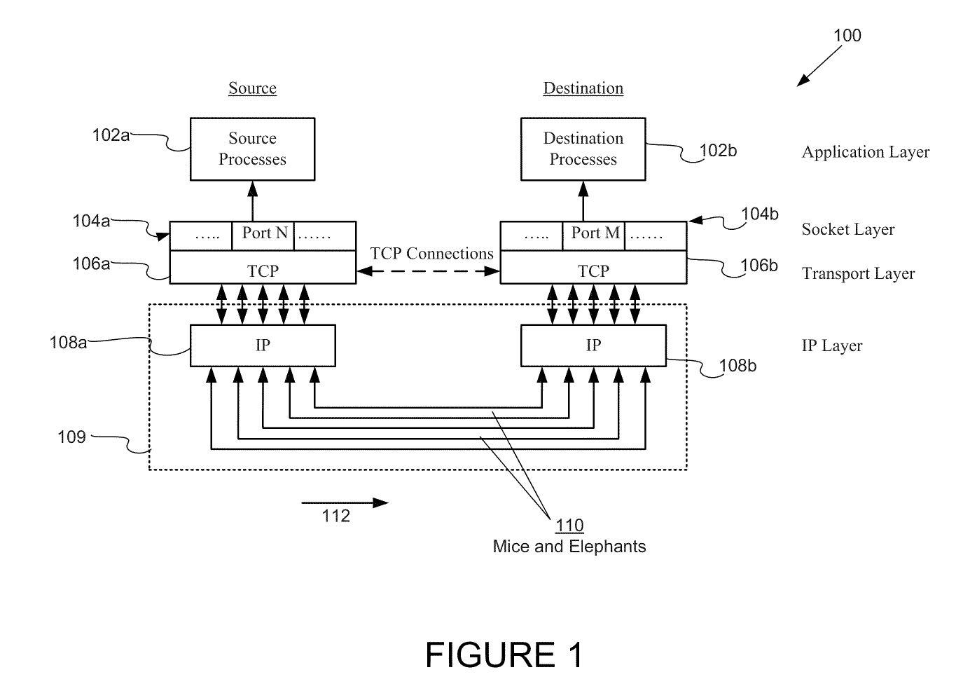

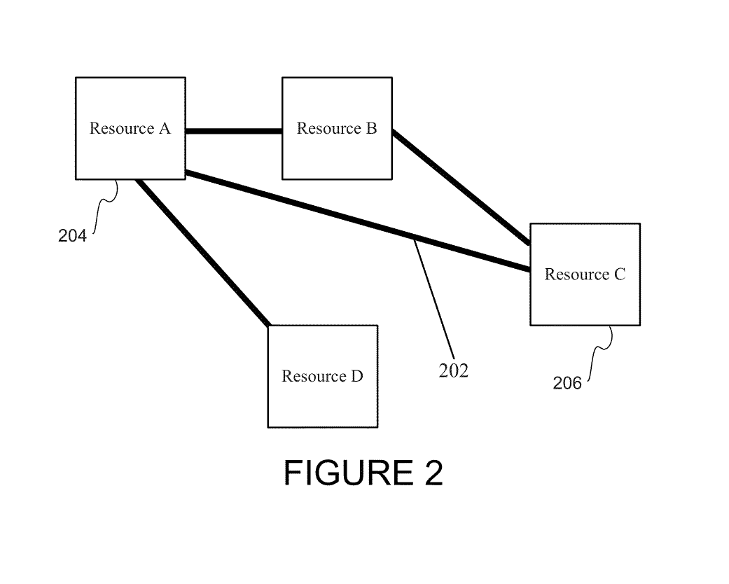

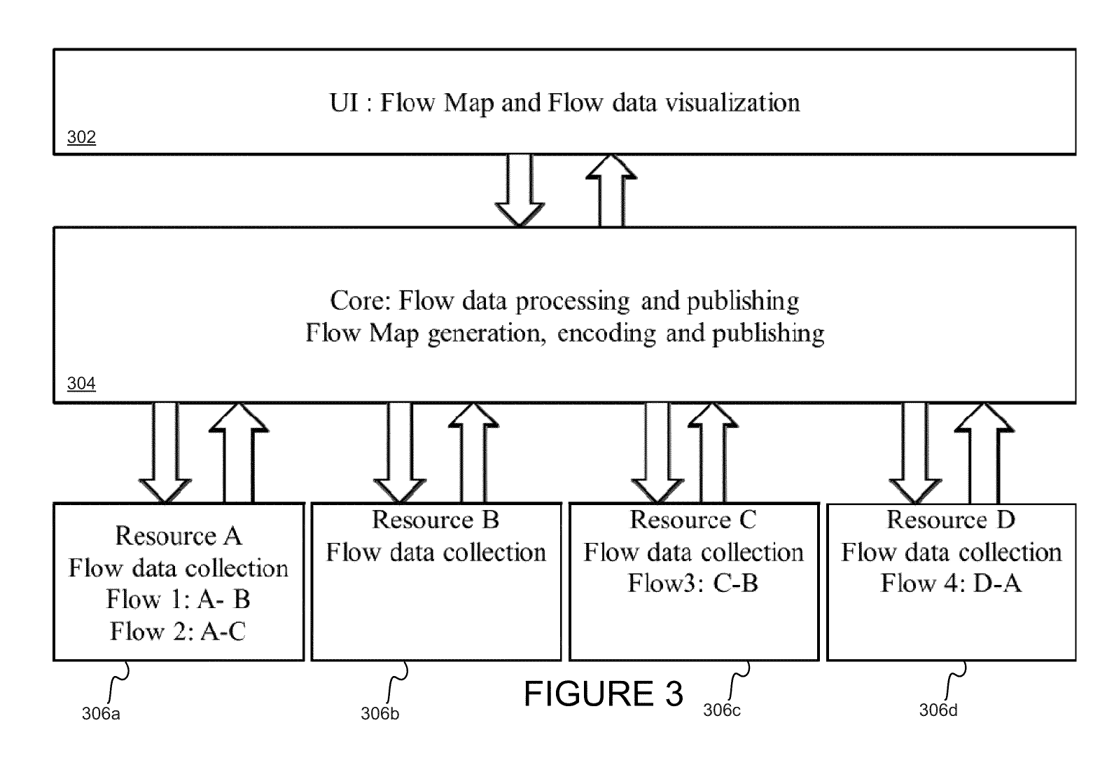

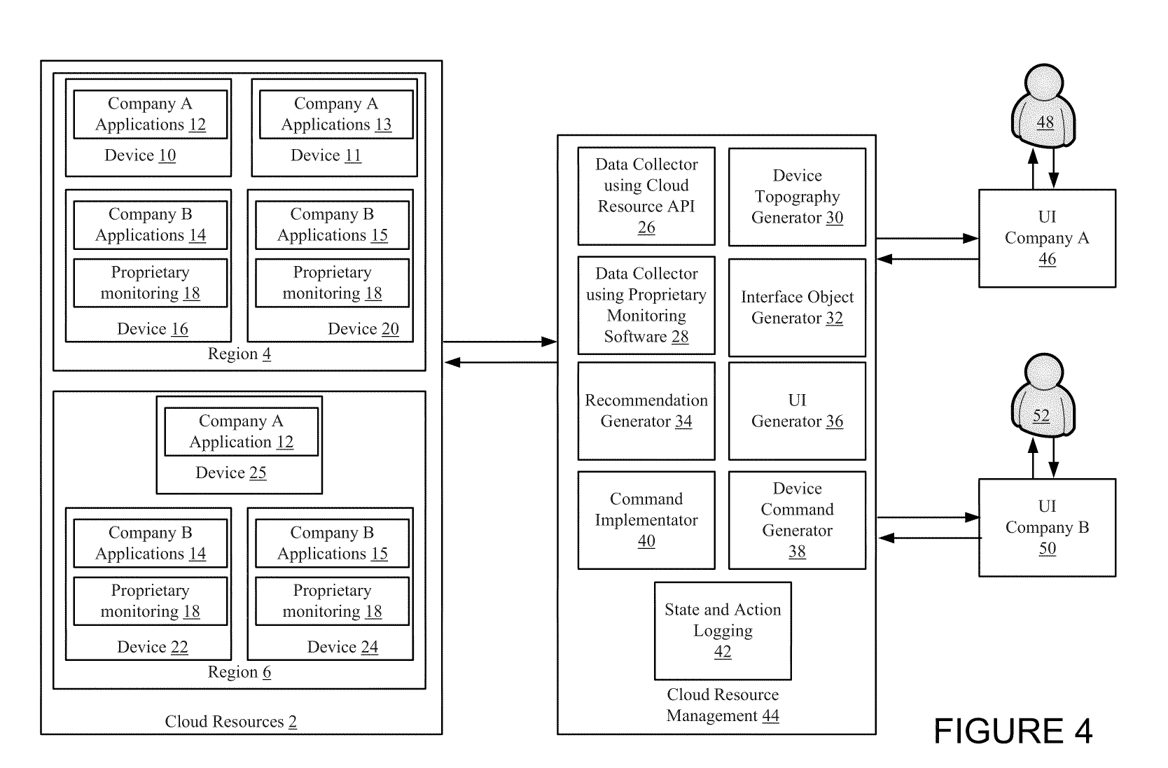

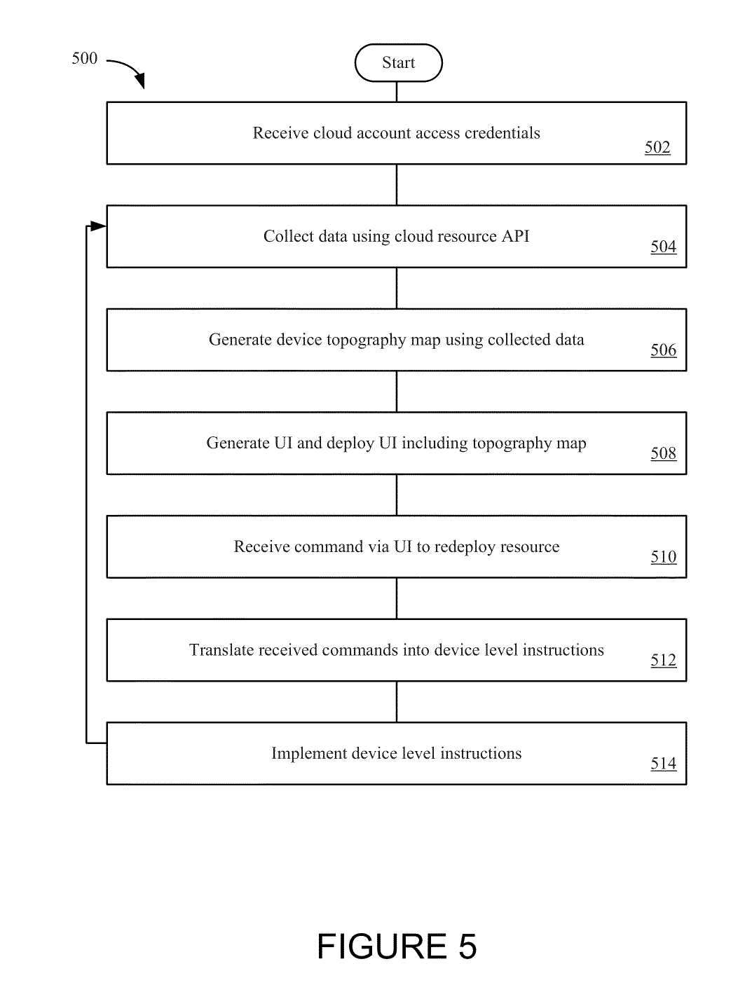

In following sections, system architecture, user interface (UI) generation, a system overview and methods that can be implemented for monitoring and managing resources are described. The system architecture section, FIGS. 1-2, describes quantities, such as paths and flows, which can be characterized by the system. A system overview section, FIGS. 3 and 4, includes components of an example system architecture for implementing one or more techniques of the present invention. The methods section, FIGS. 5-24, includes a description of methods that include the generation of a UI. The UI can be used to provision and manage virtual resources in the cloud. This UI can also be used to provision and manage virtual networks, such as software defined networks and dynamically provisionable network services, such as virtual load balancers or virtual routers in a cloud or a virtual link such as a VPN (Virtual Private Network) over a public long distance network.

### System Architecture

In the cloud, computing and communication resources are dynamically provisioned and managed to implement an application. The cloud includes software or hardware components which process, store or transport data in a cloud. There are resources which can be dynamically provisioned and managed by cloud infrastructure users and other which cannot. A resource can be a virtual machine, a virtual load balancer, a virtual router, a virtual switch or a virtual link. A manageable resource is a resource which can be reconfigured and monitored by a cloud infrastructure user. A provisionable resource is a resource which can be dynamically provisioned and allocated to a specific cloud user for a period of time.

FIG. 1 shows an abstraction of a flow path, including a source and a destination, for one embodiment. Two components of the architecture described herein are a flow and a path. A flow or path can be an abstraction of resources between a source resource and a destination resource used to carry data between two points. In one embodiment, the flow or path starts at the source's socket layer 104a and ends at the destination's socket layer 104b. The illustrated flow moves in direction 112. In a specific example, a source process 102a may initiate a flow in the source socket layer 104a, which transmits through transport layer 106a and then IP layer 108a. A destination IP layer 108b receives data from such source IP layer 108a, which is then received through destination transport layer 106b and destination socket layer 104b, and finally received by a destination process 102b.

A source or a destination of a flow or a path can be any type of logical resource. As described above, a resource is a dynamically provisioned and manageable software or hardware component which has a functional role in an application. For example, the role may be to process, store or transport data in a cloud. In one embodiment, the resource can be a logical entity. For example, it can be a virtual machine, a network service or a storage space. A resource can also be a group of similar resources. In this case, the flow between clustered resources is the aggregation of the individual flows between the clustered resources and the destination resource. This flow is also named a flow group.

The resource can be identified by its universally unique identifier (UUID). A UUID is an identifier standard used in software construction, standardized by the Open Software Foundation as part of the Distributed Computing Environment. The intent of UUIDs is to enable distributed systems to uniquely identify information without significant central coordination.

A resource can implement a transport layer, which multiplexes and demultiplexes data from different connections and communicates with the application processes via sockets. The connections are characterized by IP addresses and ports (e.g., 104a, 104b). As example, the transport layers can be UDP or TCP. In TCP/IP, every accessible server (in this case, virtual machines) has one or more IP addresses and each of those IP addresses has a large range (0-65,535) of “ports” that can be used. Connections to servers can be made based on a combination of IP address plus port. Services running on the server that accept incoming requests designate what IP/port combination they are going to listen to, and only one service can listen to any combination at one time.

A flow can represent the data exchanged between a source and a destination during a period of time. As indicated FIG. 1, a flow starts at the source transport layer 106a and ends at the destination transport layer 106b. As shown in FIG. 1, a flow is an aggregation of micro-flows (or connections). A flow can be composed by different types of microflows (or connections) 110, referred to as “elephants” (high volume, long duration) or “mice” (small volume, short duration).

As described above, to optimize the implementation of an application in the cloud, metrics that characterize the accessible underlying cloud infrastructure are useful. Metrics which characterize the activity generated by the application on this cloud infrastructure are also useful. The flow represents the activity of the application in the underlying network path. In one embodiment, a flow can be characterized at a minimum by its latency and throughput, which are both functions of time. The latency can be defined as an average time it takes for information to go from a source to a destination and back. The relevant unit of measurement is typically the millisecond. The latency metric can be applied to both flow or path objects. The throughput can be defined as a rate at which information can be reliably sent to a destination. Throughput can be expressed in terms of megabits per second (Mb/s) and it is applicable to characterizing the flow.

Other metrics can be used to characterize a flow are reliability and the number of connections. The number of connections is the number of connections composing a flow. The reliability metric can relate to packets lost and duplicated over time, a percentage of redundant information that have to been sent to recover these errors and congestion events (timeout) over time.

A path is the abstraction of the sequence of network software and hardware components between a source and a destination used to carry flow data between these two points. A path starts at the transport layer of the source and ends at the transport layer of the destination. FIG. 2 shows a path 202 between two resources 204 and 206, e.g., a source and a destination.

In the embodiments described herein, it can be desirable to characterize a path. As described above, a path is defined by its source and destination. In one embodiment, the path may be characterized by its latency and capacity. The bandwidth capacity of the path is the upper bound of the rate at which information can be sent to a destination. It may happen that a flow using a path exceeds the capacity of the path. In this case there is congestion event and flow packets can be lost. The location where this congestion occurs is referred to as a bottleneck.

Another example of a metric is congestion level. This metric can be used to evaluate the severity of the congestion of a path. The congestion level can be defined on a 0 to 10 scale. Level 0 is used for a network path that is never congested (which never drops packet because of buffer overflow) while a 10 corresponds to a path blocking or dropping almost all packets for more than 1 hour. The congestion level can be defined by the number of drops and the duration of the event. Congestion can be costly. Some studies give numbers such as $42K cost for one hour of network outage. Path congestion for one hour is considered as an outage.

The path latency can be defined as the average round trip time experienced by a packet forwarded in the path. The minimum path latency is the lower bound of the path latency observed during a period of time. The latency may be expressed in milliseconds. The latency can be represented as a time function or by its statistics (min, max, mean, standard deviation, 90th percentile, 99th percentile).

The capacity can be considered as an upper bound on the amount of information that can be transmitted, stored or processed by an allocated resource. The capacity can be represented as a time function or by its statistics. For example, the path capacity is expressed in Mb/s. The path capacity is the sum of the available capacity and utilized capacity.

The latency and capacity of a path can vary over time and are not necessarily accessible directly. In particular embodiments, these characteristics can be estimated by active probing or inferred from transported data. The capacity can be represented as a time function or by its statistics.

As described above, flow or a path can start and end in the transport layer of a resource, where TCP is one example of a transport layer that can be utilized. TCP is a transport protocol which has several functions. One TCP function is to send and receive data from/to the application process. A second function is to control the congestion within the network (specifically on the network path used by the connections). In various embodiments, described herein in more detail as follows, both of the functions and variables associated with these functions (TCP variables) can be utilized. In one embodiment, TCP variables of connections between a source and a destination can be used to estimate the flow patterns as well as to detect congestions within a path.

One of the aspects of optimization and resource management may be related to identifying and responding to communication bottlenecks. A bottleneck is a spot of the infrastructure where the activity is perturbed and slowed down. A bottleneck is a problem in the cloud network that is preventing cloud resources from operating at their full capacity. For example, this could be a slow router creating network congestion or an underpowered computing resource that causes an application to slow down.

The capacity of a path is the sum of utilized capacity and available capacity. The utilized capacity is the consumed amount of information that can be transmitted by unit of time, stored or processed by a utilized allocated resource. For a path, the utilized capacity is expressed in Mb/s. The utilized capacity corresponds to the flow throughput. The available capacity is the remaining amount of information that can be transmitted by unit of time, stored or processed by a utilized allocated resource. For a path, the available capacity is expressed in Mb/s. When the available capacity approaches zero, the flow can be considered bottlenecked. When TCP is utilized, the TCP (or TCP-friendly) connections of the flow will be forced to reduce their throughput and may experience congestion events. The congestion may materialize as packet drops and a decrease of the congestion window of the connections of the source.

### System Overview

In this section, an overview of a system providing tools that allow a user to manage their cloud resource is described. For illustrative purposes, an example topology of customer's resources in the cloud and management of these cloud resources is first described with respect to FIG. 3. Then, a system for implementing the resource management strategy described in FIG. 3 is discussed with respect to FIG. 4.

Referring back to the example of FIG. 2, four resources A˜D associated with a user's applications executing in the cloud are shown. In FIG. 3, four flows (Flows 1 and 2 of 306a, Flow 3 of 306c, and Flow 4 of 306d)) have been mapped to the resources in FIG. 2. The resources and the associated flows may have been automatically discovered by the system. For instance, a user may have provided access credentials to the system that enable the system to discover the user's current usage of cloud resources.

With respect to FIG. 3, resource topologies with more or less flows and more or less resources are possible. Further, different flow mappings between resources A, B, C and D including more or less flows is possible. In addition, the number of flows and the number of resources for a particular user can change over time. For example, at a first time the user may utilize four resources, at a second time a user may utilize three resources and at a third time a user may use six resources. From time to time, some of the flows may remain constant, new flows may be added or existing flows and/or resources may be terminated. Thus, the number of flows and their associated sources and destinations is provided for the purposes of illustration only and is not meant to be limiting.

Returning to the example in FIG. 3, resource A can collect flow data for a first flow between resource A and B and a second flow between A and C as shown by 306a. Resource C can collect flow data for a third flow between C and B as shown in 306c. Resource D can collect flow data for a fourth flow between D and A as shown in 306d. Resource B may have the ability to collect flow data but, in this example, the collected data is not associated with any flows (306b). To enable the data collection measurement software may have been previously download to the resources.

The measurement software on each of the resources can acquire data and send the acquired data to a core 304 for processing. The data acquisition can be an ongoing process where the measurement software is acquiring at different times. The data acquired over time can be used to characterize resource performance over time. In one embodiment, the measurement software on each resource may acquire data in an asynchronous manner from one another. Thus, the core can be configured to perform operations that involve synchronizing the data received from each of the resources such that it can be output in a time consistent manner.

Besides processing the data acquired from the resources, the core can be configured to automatically discover the resources for a user, such as resources A, B, C and D, generate a topology of the resources, deploy instrumentation to collect flow data, determine the flows between the resources, process the acquired data to generate path and flow characterization metrics publish results and process the flows to generate a network graph of flows. In one embodiment, the results can be published via a UI 302 that provides flow maps and flow data visualization for the various discovered resources. Further, the UI can be used to perform actions which affect the resources.

With respect to FIG. 3, a system configured to perform some of the core and UI functions is described. In FIG. 4, for the purposes of illustration, an example configuration involving resource performance visualization and management for two different companies, company A and company B is discussed. Company A and company B utilize cloud resources 2. Company A and company B may each have a distinct set of customers that utilize the applications provided by each company. Company A and company B are typically unaware of each other's resource utilization in the cloud.

The cloud resources 2 are distributed in two different regions, region 4 and region 6. Typically, regions refer to separate geographic locations, such as resources located in the eastern United States and the western United States or resources located in United States and Europe. The resources are distributed to serve users of the applications in a particular geographic area. The allocation of resources in relation to demand in a particular area affects application performance. Thus, the assessment and visualization of the performance of cloud resources according to region can be important.

In the example of FIG. 4, a first set of applications 12 associated with company A are executing on device 10 in region 4, a second set of applications 13 associated with company A are executing on device 12 in region 4 and a second instantiation of the first set of applications 12 associated with company A are executing on device 25 in region 6. Further, a first set of applications 14 associated with company B are executing on device 16 in region 4, a second set of applications 15 associated with company B are executing on device 20 in region 4, a second instantiation of the first set of applications 14 associated with company B are executing on device 22 in region 6 and a second instantiation of the second set of applications 15 associated with company B are executing on device 24 in region 6. As described above, the devices can refer to logical entities. For example, device 10 can be a single virtual machine or a cluster of virtual machines. In addition, a set of applications executing on a device can include multiple instantiations of one or more applications within the set where the number of instantiations within the set can change over time.

The different sets of applications can communicate with one another to complete a task. For example, the first set of applications 12 for company A on devices 10 and 25 may each communicate with the second set of applications 13 on device 11. As another example, the first instantiation of the first set of applications 14 associated with company B on device 16 can communicate with the first instantiation of the second set of applications 15 associated with company B on device 20 to complete a task. In addition, the second instantiation of the first set of applications 14 associated with company B on device 22 in region 6 can communicate with one or both of the first instantiation of the second set of applications 15 on device 20 in region 4 or the second instantiation of the second set of applications 15 on device 24 in region 6 to complete a task.

In one embodiment, proprietary monitoring software can be deployed. However, its deployment is optional. The proprietary monitoring software can be executed in conjunction with the applications to provide additional measurements that can be used to characterize application performance in the cloud. However, even without the deployment of the software, some useful performance measurements may be obtained using functions that are native to the cloud resource, such as functions available via a cloud resource API (Application Program Interface) or a Network monitoring API. Thus, embodiments with and without the proprietary monitoring software are possible. In the example of FIG. 4, additional monitoring software 18 has been deployed for the applications executed by company B but not for the applications executed by company A.

The applications, the devices on which they execute and the communication patterns form a topology in cloud. As described in more detail as follows, the system can be configured to discover different sets of applications executing in the cloud including patterns of inter-device communication that the applications utilize, generate metrics as a function of time that characterize that resource performance including inter-device communication and abstract a topology. The performance information can be mapped to the abstracted topology. The topology and its associated information can be presented in a user interface (UI). Besides the topology, the UI can provide a number of different services for managing the discovered cloud resources in real-time. The topology is abstracted and visually formatted in the UI to present information in a manner that makes managing the cloud resources simple and intuitive. The topology is also encoded in an XML format so that the user can access in an online or offline manner. VXDL is for example a virtual network description language which can be expressed in XML.

In FIG. 4, the cloud resource management 44 is configured to provide the functions described in the previous paragraph. Cloud resource management 44 communicates with the cloud resources 2 and generates user interfaces for managing the cloud resources. In this example, the cloud resource management 44 is shown generating two UI's simultaneously, a first one 46 for company A and a second one 50 for company B. The UI's can receive inputs that trigger actions by the cloud resource management 44, such as inputs from user 48 and user 52. The UI's can be presented remotely on company controlled devices.

The cloud resource management 44 can be implemented on one or more electronic devices including processors, memory and network interfaces. Some examples of the functions that can be provided by the cloud resource management 44 are as described as follows. Data collector 26 uses native cloud functions, such as a cloud resource API, to collects data for a resource topography map that can be output in a UI. It can automatically discover a company's resources in the cloud. This function doesn't require proprietary software deployed to and running on cloud devices. However, if the proprietary software is deployed, data acquired from 26 and the proprietary software can be combined in some manner and then output to a UI.

Data collector 28 receives data from proprietary monitoring software executing in the cloud. In one embodiment, the received data can be used to generate paths and flows that are output to the UI or to an API. Device topography generator 30 generates a device topography map with or without flows depending on the data collected. Different topography abstractions are possible. Thus, the device topography generator 30 can be configured to generate one or more different topography maps depending on the abstraction that is utilized. In one embodiment, the UI may allow a user to select from among group of different topography abstractions one or more maps to be presented in the UI.

The interface object generator 32 generates and formats data for presentation to user in UI. For example, in one embodiment, the interface object generator 32 may generate flow and path objects that are used in a device topology map. The recommendation generator 34 can be configured to analyze data acquired from the cloud resource and determine actions that may improve the performance of the applications executing in the cloud. The actions can be presented as recommendations in the UIs, such as 46 and 50, where the UI provides mechanisms for allowing a user, such as 48 or 52, to indicate they wish to implement the recommendation. The UI Generator 36 generates and controls a UI that can include recommendations, topography map and interface objects for each user (e.g., company A and company B).

The device command generator 38 can be configured to generate commands for actions triggered via the UI. Actions in the UI can be presented in a high-level format. For example, a user may indicate they wish to move an execution of an application from a first virtual machine to a second virtual machine by dragging a symbol associated with the application from the first virtual machine and placing it in the second virtual machine using a cursor or some other control mechanism. In response to this action, the device command generator 38 can generate a sequence of low-level commands to implement the action on the two devices. For instance, commands can be generated by the UI that cause the first virtual machine to shut down a resource running application and cause a new instantiation of the resource with the application running to be generated on the second virtual machine. The action can also involve moving the entire virtual machine from one network to one another with less congestion.

The command implementator 40 communicates with specific devices to implement commands determined from the device command generator 38. The command implementator 40 can be configured to communicate with the affected resources and keep track of whether the action has been successfully completed or not. The state and action logging 42 can be configured to log actions that are implemented, such as actions triggered from inputs received via the UI. Further, the state and action logging 42 can be configured to saves snap shots of a topology maps showing a state of user resources at various times. For example, the snap shots can be taken before and after a user implements one or more actions via the UI. Then, the snap shots can be shown side by side in the interface to allow the user to visually assess whether the actions had their intended effect.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, flash memory, memory sticks, magnetic tape, and optical data storage devices. The computer readable medium can also be distributed over network-coupled computer systems so that the computer readable code is stored and executed in a distributed fashion.

Methods for Cloud Resource Management including an Actionable UI

Next, with respect to this section a number of methods that can be implemented using the system of FIG. 4 are described. The methods can involve generating and responding to input received via a UI that is generated by the system. In a first method described with respect to FIG. 5, a network topology map is generated and output to a UI. A network topology map displays the arrangement of the various elements provisioned by the Cloud user (e.g., virtual links, virtual resources) in one tenant network.

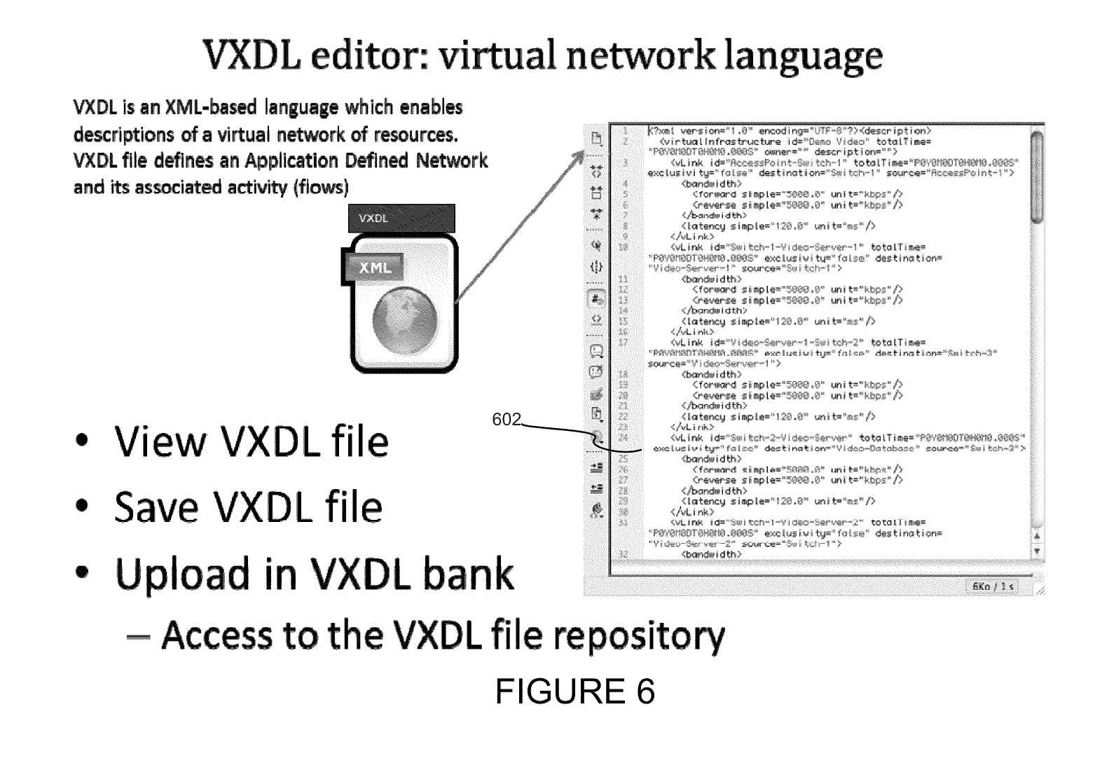

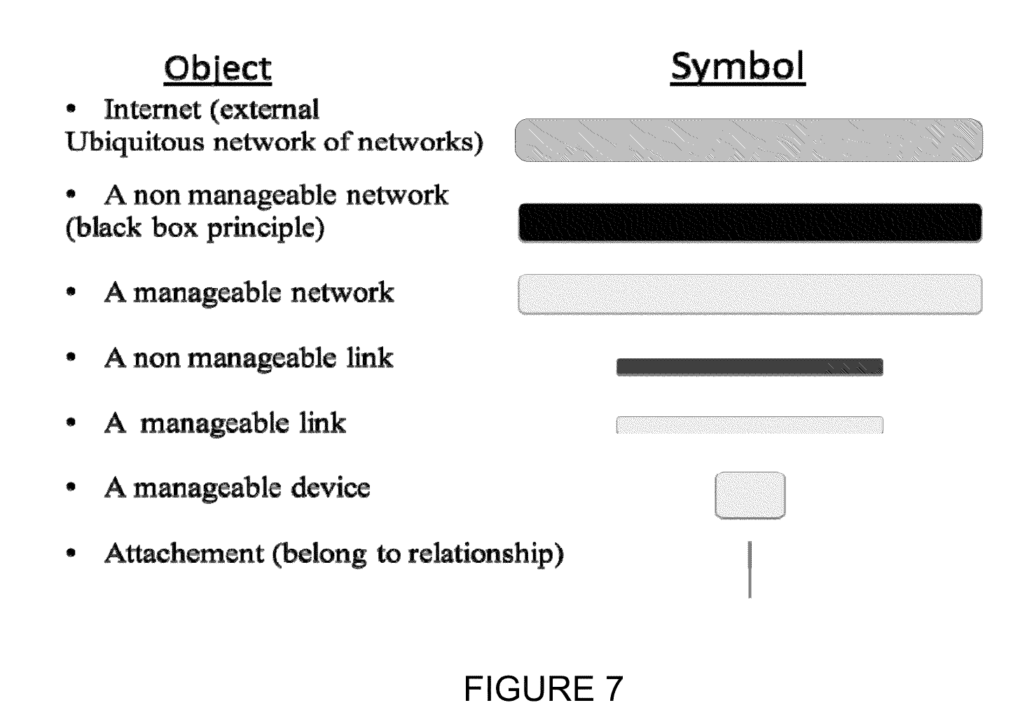

In the embodiment of FIG. 5, the network topology map is generated without using proprietary software deployed to the virtual machines. In one embodiment, the network topology map can be represented in VXDL as discussed with respect to FIG. 6. The UI that is generated allows a user to interact with the network topology map to initiate a number of different actions. Details of a network topology map and screen shots of the actionable UI in states that allow the actions are described with respect to FIGS. 7-16.

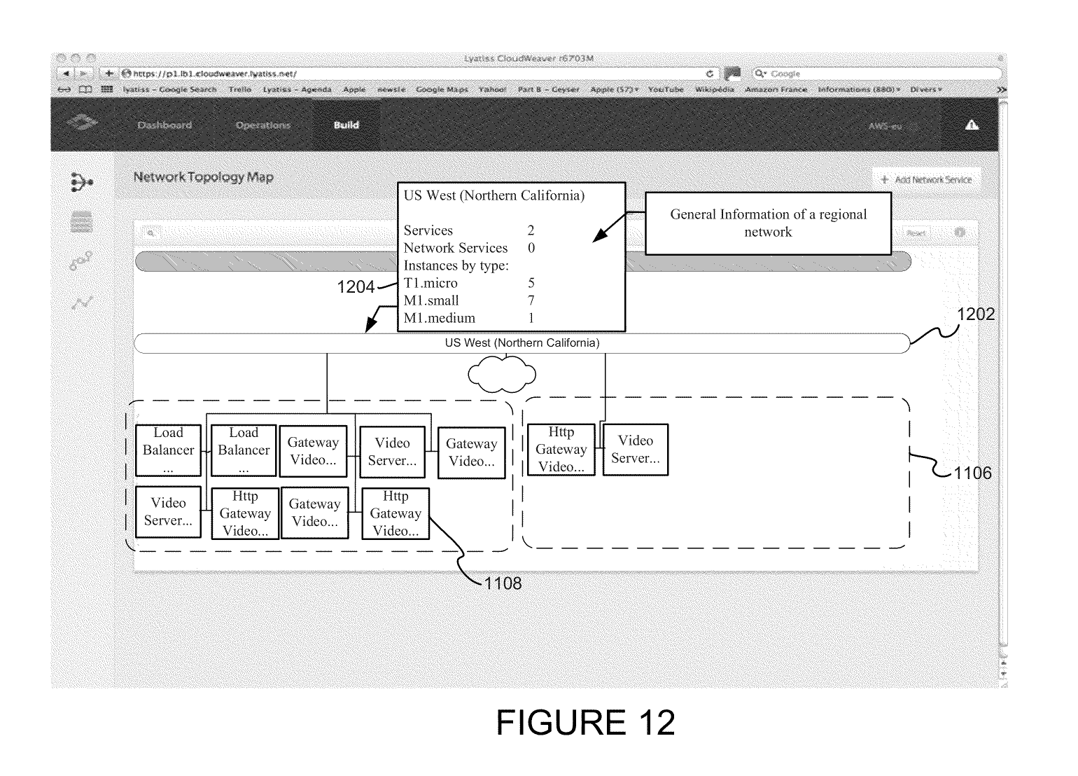

Next, in a second method, a flow map is generated. A flow map displays the application graph with flows between nodes. Flows represent the usage of the network from one virtual resource to another. The flow map can be generated using the proprietary monitoring software deployed and executed in the cloud in conjunction with the user's applications. The UI which is generated includes the flow map and can be actionable. Screen shots of the UI in states that allow the actions are described with respect to FIGS. 12-16.

Returning to FIG. 5, a flow chart of a method 500 for generating a UI for managing cloud resources is shown for one embodiment described herein. In 502, the system can receive cloud account access credentials. For example, a login name and password can be received. The cloud account access credentials allow the system to discover and/or gain access to a user's cloud resources for modification purposes.

In 504, using the credentials, the system can collect cloud resource data. For example, the system can connect to a cloud resource API and/or parse a cloud infrastructure description file. Next, a list of cloud resources can be obtained. The list can be analyzed to extract networking information for each resource, such as UUID's and IP addresses for each resource. The list and organization of cloud resources can also be obtained via an XML-based file (for example a VXDL file can be utilized in one embodiment).

An example of a VXDL file portion 602 is shown in FIG. 6. The Virtual private eXecution infrastructure Description Language (VXDL) is a language that allows the description of a Virtual Private eXecution Infrastructure (ViPXi) or a resources graph. A VIPXI is a time-limited organized aggregation of heterogeneous computing and communication resources. It describes interconnected end resources for data processing or storage, but also the network's topology, including communication equipment and timeline representation. The ViPXi concept and its associated VXDL description language brings two aspects to the infrastructure as a service paradigm (IaaS), both related to the networking aspects: (i) the joined specification of network elements and computing elements and (ii) the link-organization concept, which permits a simple and abstract description of complex structures. The VXDL language primarily enables the description of resources and networks that are virtual.

Returning to FIG. 5, in 506, a network topography map can be generated using the collected data. The map can be generated by recomposing the hierarchy of networks and resources using a selected abstraction. An internal model of the system can be created in accordance with the selected abstraction. Next, an actionable representation of each discovered network object, network service object and discovered resource object can be generated. When displayed in the UI, one or more actions may be possible from each actionable representation of an object.

In 508, the UI can be generated and deployed. For example, the UI can be output on a remote device. The UI can display the hierarchy of actionable representations of the network objects, network service objects and resource objects.

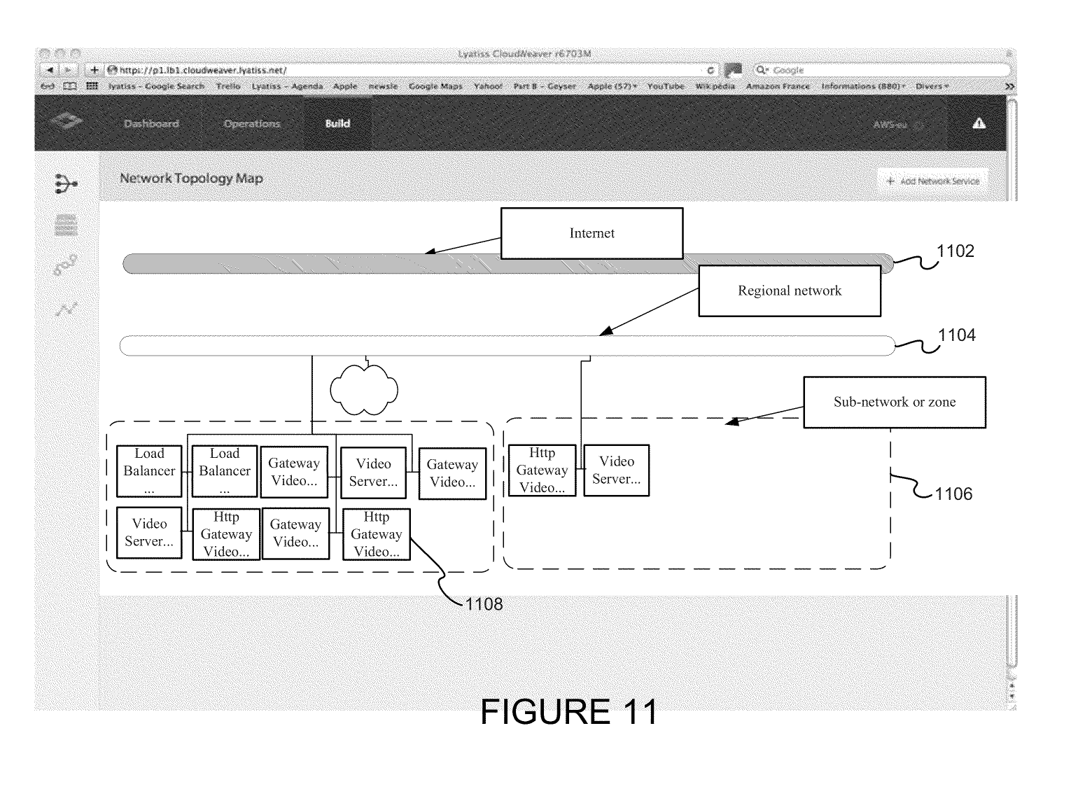

In more detail (also see FIG. 11), the system can display via the UI a representation of the Internet 1102 as the “root” of the network. The Internet can be coupled to regional networks (e.g., 1104). Within the regional networks (e.g., 1104), representation of sub-networks or zones (e.g., 1106) can be displayed. In addition, zone and sub-network information associated with sub-network or zone resources can be displayed.

Network services, which are actionable, can be displayed at their place in the hierarchy of the network topology map. General and detailed information about each network service may be made available. Further, end resources (e.g., 1108), which are actionable, can be displayed at their place in the hierarchy. General and detailed information may also be provided about each end resource. In one embodiment, the Internet accessibility of each end resource can be displayed, such as a fixed or dynamic public address.

In 510, the UI can receive an input that triggers an action by the system. For example, the system can receive an action that causes a resource to be redeployed from execution on a first resource to execution on a second resource. In 512, the action can be translated into a number of device level instructions. A single action may involve multiple device level instructions. In 514, the system can implement the instructions on each of the affected devices. The automation of this process by the system can reduce the work load for users and errors associated with typing in many different device level instructions.

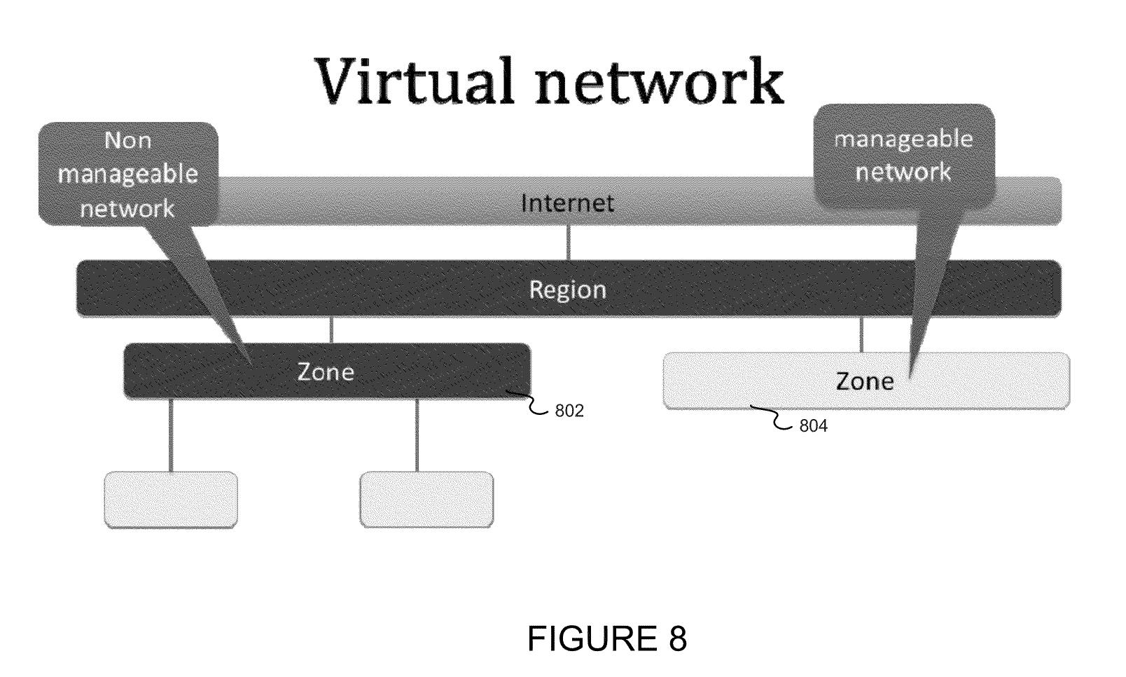

Next, screen shots illustrating some of the details of the method discussed with respect to FIG. 5 are described with respect to FIGS. 8 through 16. In FIG. 7, some objects and representative symbols that can be used in a network topology map are shown. The Internet, which is a ubiquitous external network, can be represented as a bar with a first color (shown as gray). A non-manageable network can be represented as bar of a second color (shown as black). A manageable network can be represented as a bar as a third color (shown as white). Manageable and non-manageable links can be represented as lines of two different colors. Manageable and non-manageable devices can be represented as boxes of two different colors. Finally, an attachment can be represented as a slender line. An attachment represents an “inclusion” relationship. FIG. 8 shows a virtual network including some of the objects shown in FIG. 7. In particular, a manageable network zone 804 and a non-manageable network zone 802 are each shown.

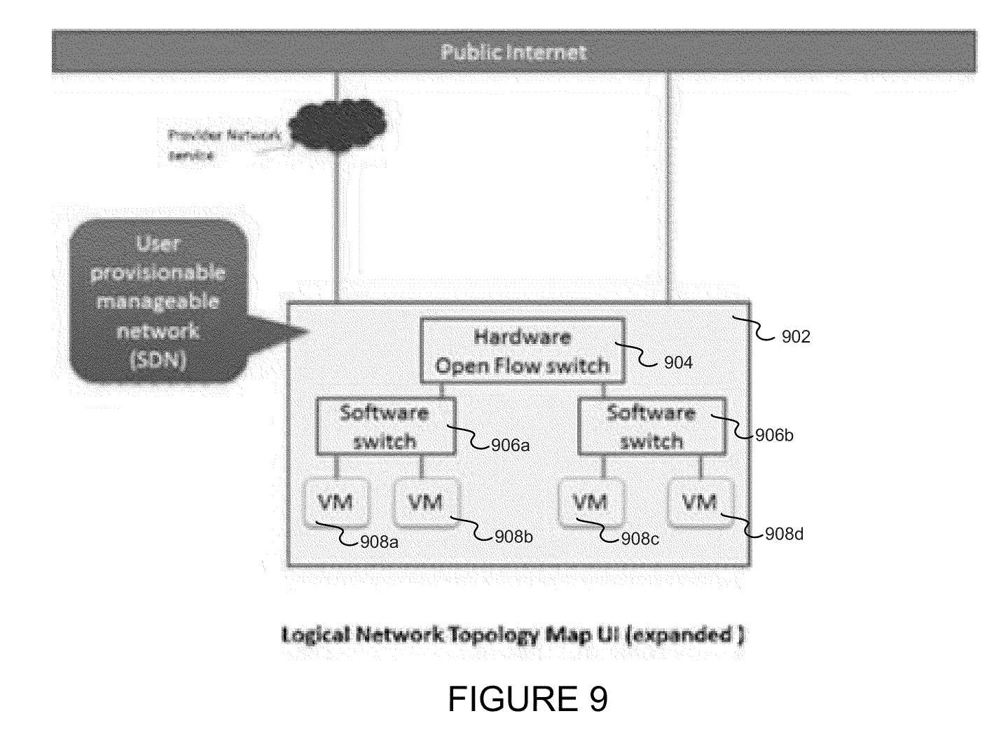

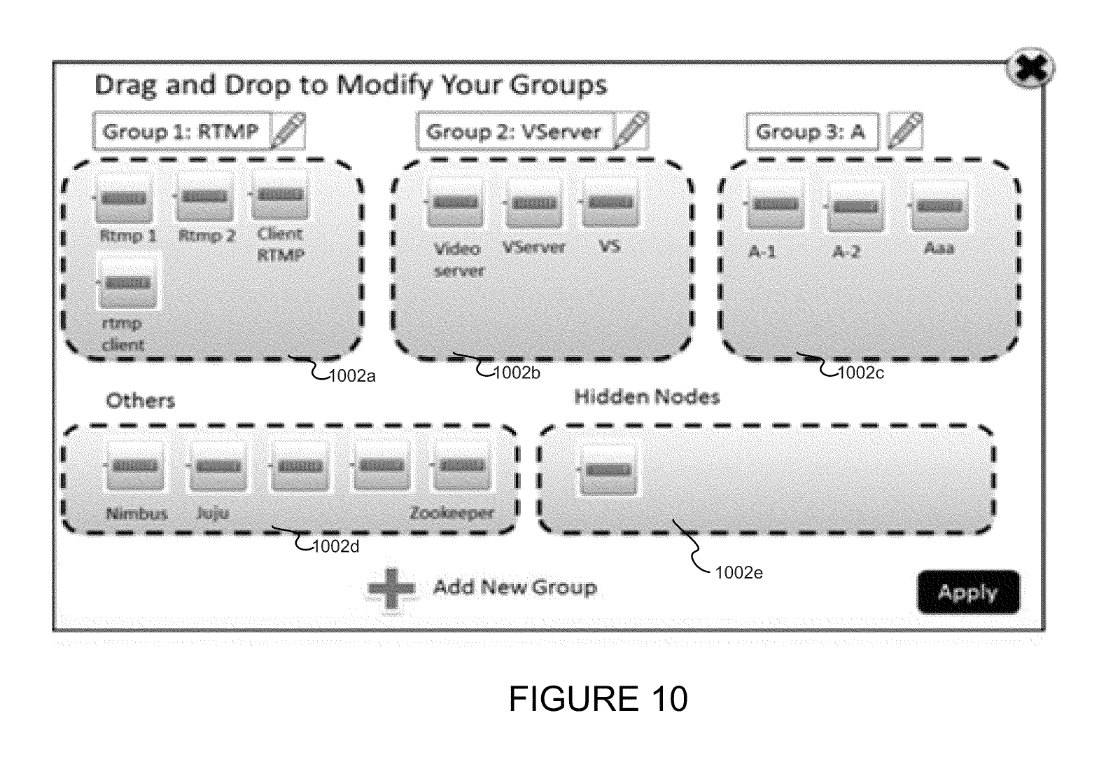

In particular embodiments, it may be possible for a user to interact with the UI such that different levels of detail associated with the virtual network are shown. In FIG. 9, additional details of a manageable network object or node 902 is shown. The node 902 is a user provisionable manageable network (SDN). The node 902 includes a hardware open flow switch 904, two software switches (906a and 906b) and four virtual machines (908a-908d). A UI state for configuring groups of nodes is shown in FIG. 10. Via the UI, a user may be able to use a “drag and drop” feature to add or remove elements from the different groups (1002a-1002e) and can directly access network resource configuration actions, such as changing a routing table or a flow control policy.

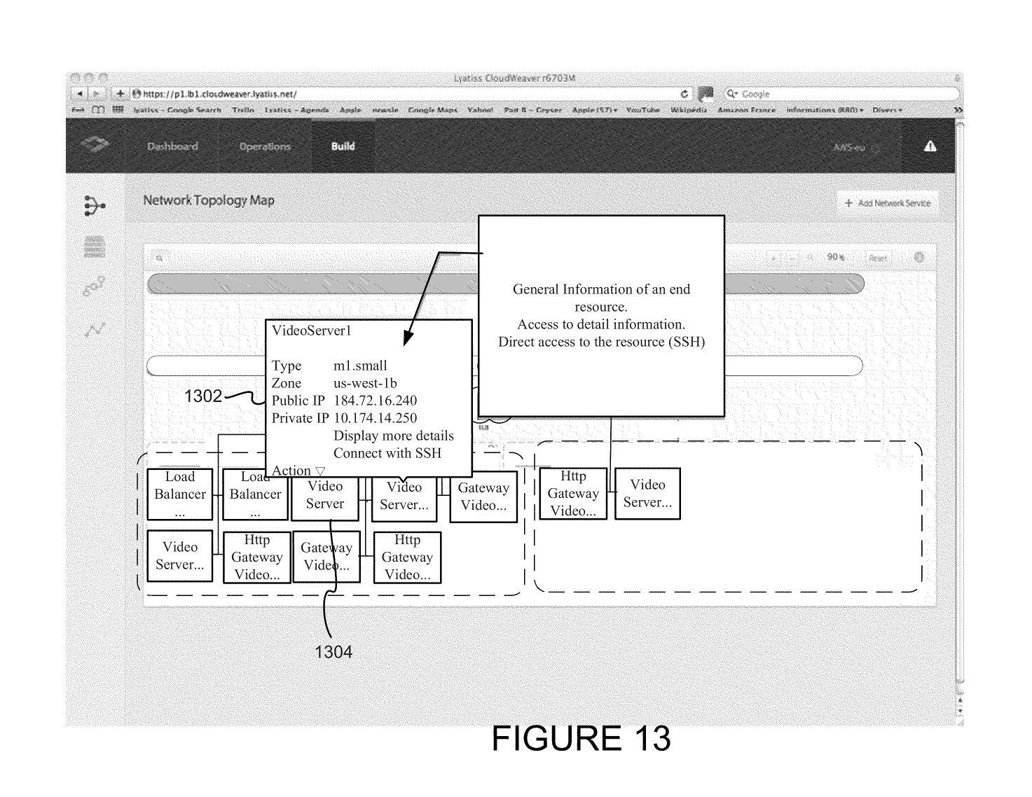

Next, with respect to FIGS. 11-16, a number of UI states including a network topology map are described. In FIG. 11, a screen shot of a representation of the Internet at the root level, a regional network, a sub-network zone and an end resource are shown. In FIG. 12, a UI state is shown where a user interaction has caused information 1204 associated with the regional network 1202 to be displayed. In the example, the regional network 1202 is in Northern California. In FIG. 13, a UI is state is shown where a user interaction has caused information 1302 associated with an end resource 1304 to be displayed. In this example, the resource 1304 is a video server.

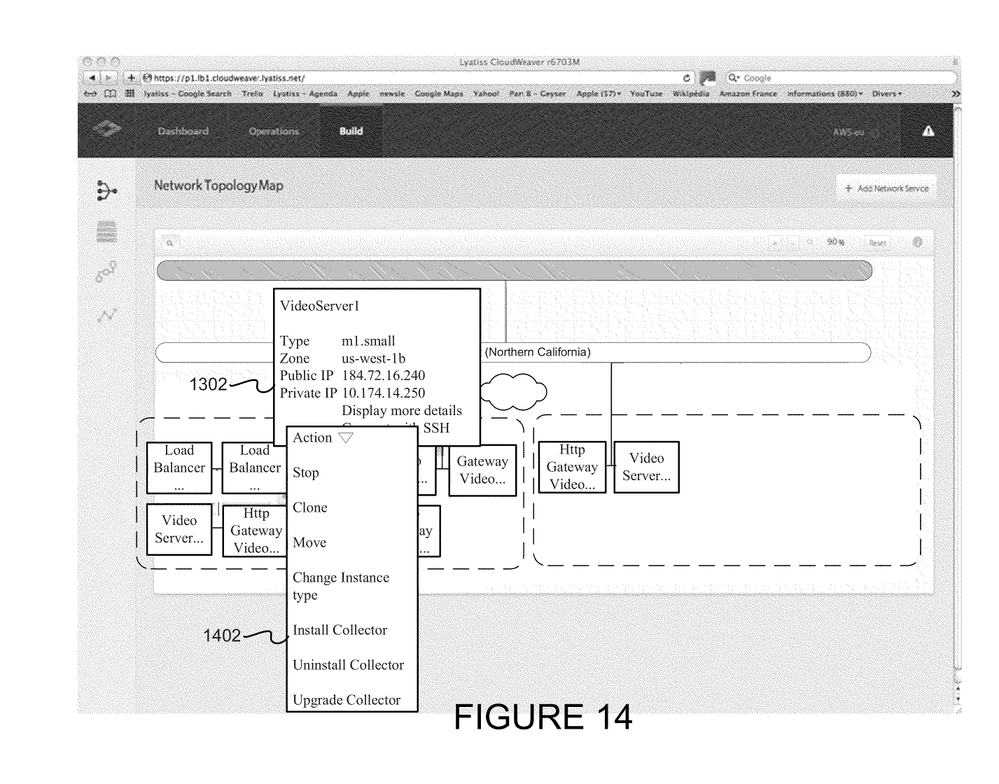

In FIG. 14, an UI state is shown where the user has interacted with the interface to pull up a series of actions 1402 that can be performed on an end resource. In this example, the user can stop, close, move or change the instance type of the video server. In addition, a user may be able to install a “collector.” The collector refers to the proprietary monitoring software described with respect to FIGS. 5 and 6, which can acquire data. When a collector is already installed, the user can be provided with the option of uninstalling the collector or upgrading the collector. Upgrading the collect may involve installing a new collector with added features.

As described above, implementing an action can involve translating a high-level command received from the UI into a series of low-level commands. For example, after a user has confirmed a move, the system may perform one or more of the following steps: 1) the virtual resource is stopped, 2) a snapshot of the virtual resource's root volume is taken, 3) snapshots are taken of all the storage volumes attached to this instance, 4) a new instance is started in the new selected zone using the original instance's root volume snapshot, 5) the snapshots of the original storage volumes are attached to the new instance, 6) if the original instance has reserved public IP Address, it is moved to the new instance, 7) if one or more load balancers were pointing to the original instance, then they are updated to point to the new instance, 8) If the option “Transfer Flow history to the new Instance” is selected and a flow history is available, then the original Instance can be renamed to “<Original Instance Name> (MOVED_TO_<New Zone Name>)” and the flow data history of the original Instance can be moved to the new Instance and 9) the original Instance is stopped. If an error occurs at any step during this action, then the action can be rolled back and the original Instance can be restored along with its Elastic IP Address association (if the instance had one). The backed-up snapshots of the root and other storage volumes are not deleted in one embodiment.

The method described in the previous paragraph can be cloud resource specific depending on the provider of the cloud resource. For example, the method as applied to Amazon's cloud resource can involve one or more of the following steps, 1) the instance is stopped, 2) an EBS (Elastic Backed Storage)-backed snapshot of this instance's root volume is taken, 3) snapshots are taken of all the EBS storage volumes attached to this instance, 4) a new instance is started in the new availability zone using the original instance's root volume snapshot, 5) the snapshots of the original EBS storage volumes are attached to the new instance, 6) if the original instance has an elastic IP Address, then the elastic IP Address is moved to the new instance, 7) if one or more Amazon elastic load balancers were pointing to the original instance, then they are updated to point to the new Instance, 8) if the option “Transfer monitoring to the new instance” is selected, then the original instance will be renamed to “<Original instance name> (MOVED_TO_<New Availability Zone Name>)” and the system can transfer the monitoring history of the original Instance to the new Instance and 9) the original instance is stopped. Similar to the example above, if an error occurs during one of the steps, the action can be reversed such that the original configuration before the action is restored.

As other examples, the UI can enable a user to perform the actions of creating and configuring a load balancer. In the case of a cloud-based load-balancer, a call to API's of the provider can be made to provision the load balancer. Using the UI, a user can then be guided through the steps needed to configure the load balancer. In one case, load-balance is a VM-based software. A call to the APIs of the provider to provision a VM can be made. Then, a software image of the load balancer can be deployed. The image may include a configuration agent. Next, the agent on the load balancer image can be activated. The core system can create a configuration file that is downloaded to the agent. The agent may configure the load per the configuration file. The agent may then restart the load balance process executing on the VM.

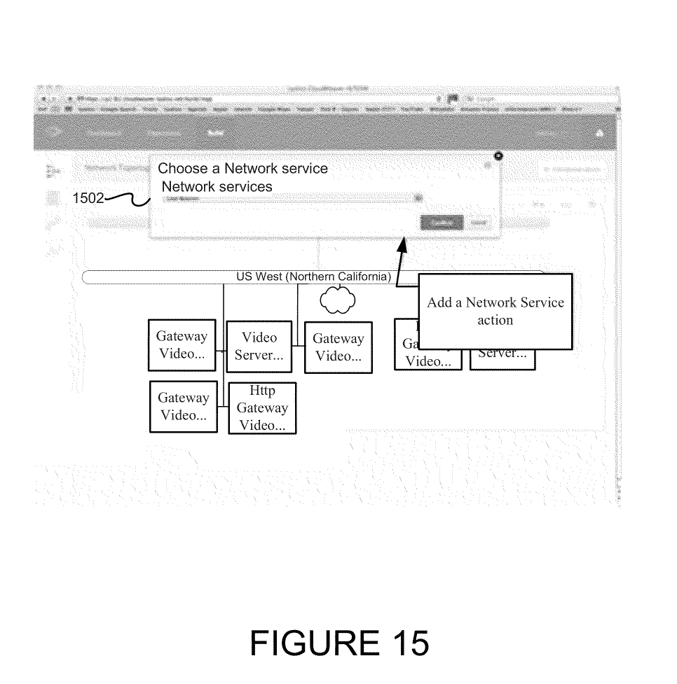

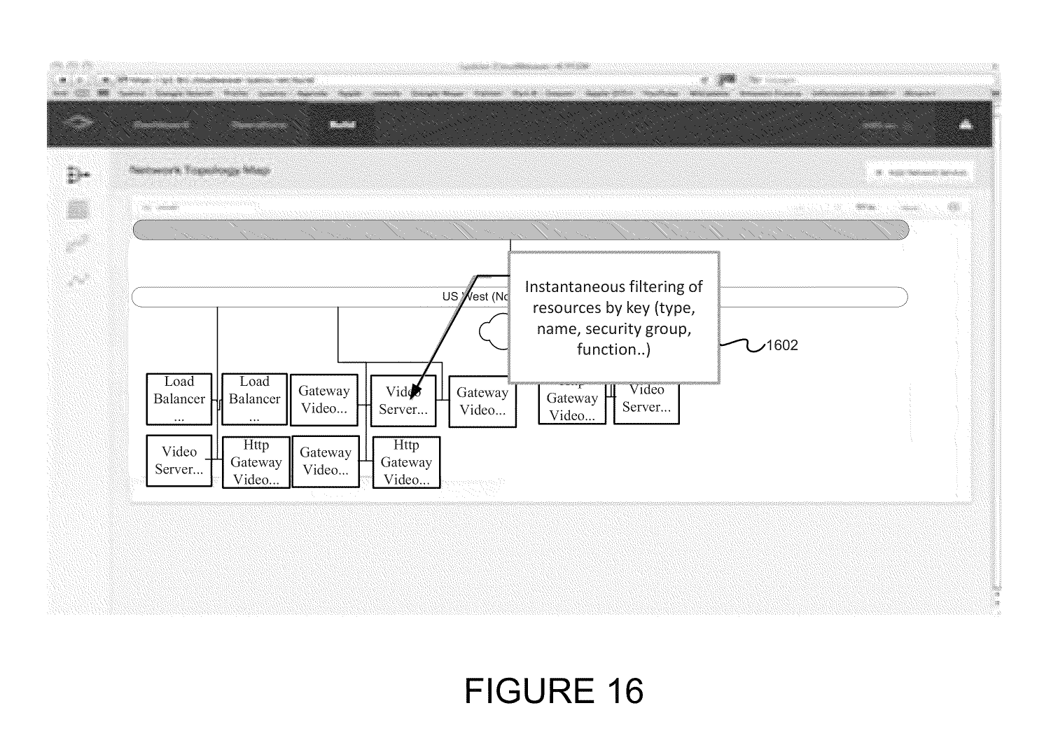

In FIG. 15, a UI state 1502 is shown where the user has interacted with the interface to add a network service. In this example, the user is adding a load balancer. In one embodiment, the user can execute various filtering commands. For example, the UI can be configured to allow a user to filter resources by type, name, security group, and function, etc. FIG. 16 includes a screen shot with an example of one type of filtering protocol being applied (1602). The resources to which the filtering criteria have been applied are highlighted.

Second Method involving a UI and including Flows

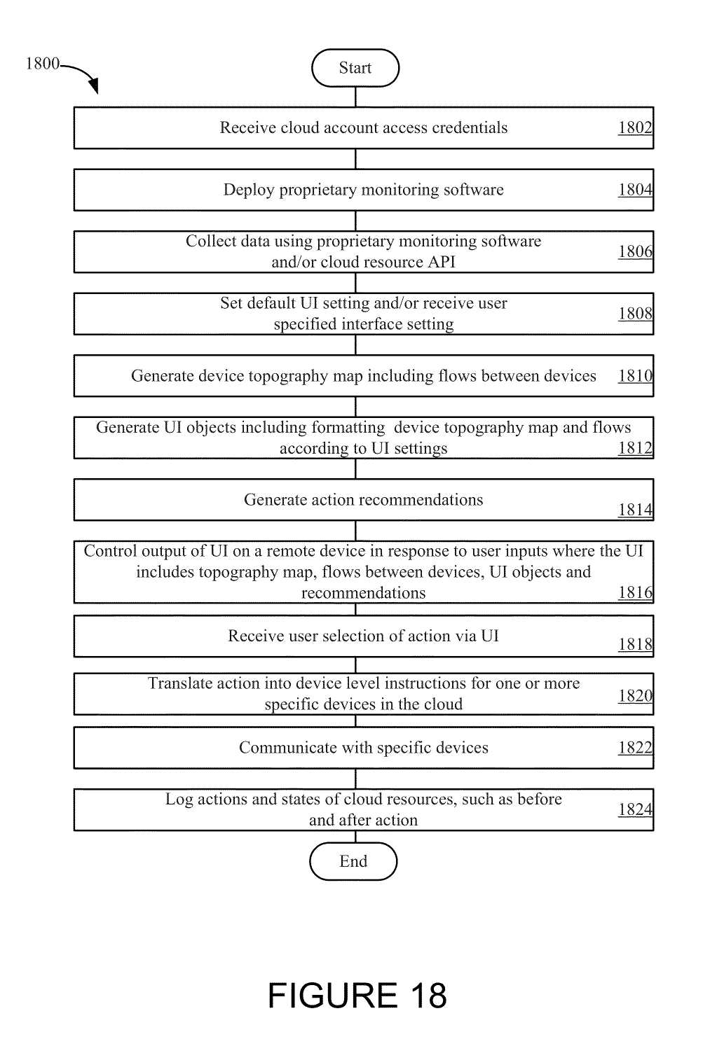

Next, a second method 1800 is described for managing cloud resources is described with respect to FIG. 18. This method utilizes proprietary monitoring software deployed within the cloud. A collector described above with respect to FIG. 14 is one example of proprietary monitoring software. The proprietary monitoring software can be used to add additional features to the UI, such as objects that provide a status of network communications between the various resources.

In one embodiment, the UI can generate and display a flow map. The flow map displays the application graph with flows between nodes. The flows can represent the usage of the network from one virtual resource to another. A flow list generated by the UI can display the activity and corresponding health (time-series (charts) and statistics with user-defined alert thresholds) of each flow. A node list generated by the UI can display activity and corresponding health (time-series (charts) and statistics with user-defined alert thresholds) of each node. In addition, along with the flow map, the UI can generate snap shots and heat maps. A snap shot can display quantities, such as top utilized resources (hotspots & potential bottlenecks), top flows (max throughput, max activity) and top flow latency (highest latency). The flows can be sorted according to these different parameters. A heat map can prove a representation of network performance where the individual values (latency & available capacity) of the network path matrix are represented by gradual colors. In this matrix, the row and lines corresponding to paths with activity, the flow statistics are represented.

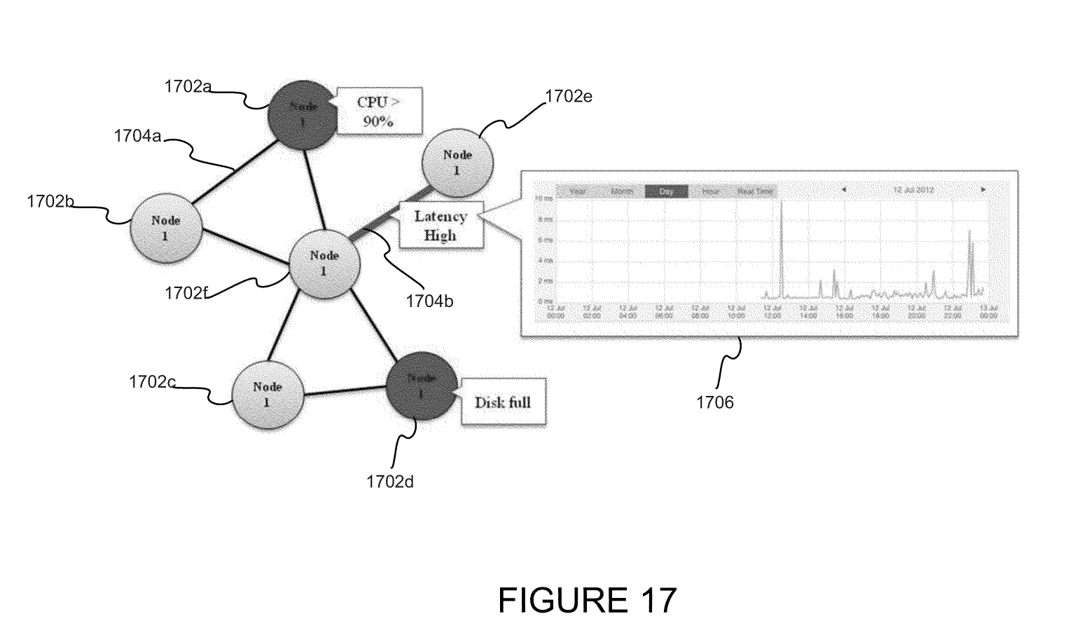

The visual representation can be geared toward providing information that aids in managing the cloud resources. In one embodiment as shown below in FIG. 17, a flow map can be generated to display congestion or bottleneck events. The flow map includes 6 nodes (e.g., 1702a-1702f) and 7 flows (e.g., 1704a and 1704b). Two nodes (1702a and 1702d) and one flow (1704b) are high-lighted because of resource issues. Node 1702a has a CPU usage greater than 90%. A second node 1702d has a disk near capacity. The flow 1704b is identified as having a high latency. A resource graph 1706 associated with the latency may be displayed to provide additional insight into the latency issue.

Next details of the method and UI states associated with the method that include flow maps are described with respect to FIGS. 18-22. Returning to FIG. 18, in 1802, the cloud account access credentials can be obtained. Then, as described above with respect to FIG. 5, an initial network topology can be generated or a previously generated network topology map can be loaded by the system. In 1804, the proprietary monitoring software can be deployed. The monitoring software can be deployed automatically by the system or manually by the user. After deployment, the UI allows a user to affect the distribution of the monitoring software. For example, a user can uninstall certain instantiations of the software on different resources if they desire.

In 1806, the system can acquire data from the cloud resource API and/or the proprietary monitoring software. In 1808, the system can set default UI settings and/or receive user specified UI settings. In one embodiment, the UI settings can affect how particular objects, such as flow objects are displayed in the interface. In 1810, a device topography map including flows can be generated. In 1812, the UI objects can be generated in accordance with the UI settings. For example, in one embodiment, a flow object can be rendered in a red color if a congestion level on the flow exceeds some threshold value selected by the user.

The generation of the flow objects can include connecting to a flow engine to get a list of active flows. Then, charts and statistical information can be generated for each flow. Next, the flow map can be constructed. The flow map can include nodes that are connected to each of the flows. Each node can represent a resource. Actionable objects which represent each node can be generated. The flow map can be organized hierarchically by tiers or by functional groups. A representation of the Internet network can be anchored at a fixed place of the screen. Next, an actionable representation for each flow can be generated. In one embodiment, a graph including flows and nodes can be output to the interface.

In 1814, action recommendations can be generated. For example, if one of the flows indicates that congestion is present, the system can be configured to generate an action for alleviating the congestion. The recommended actions can be output and presented to a user via the UI. The system can be configured to implement an action after receiving confirmation from a user. In 1816, the system can control output of the UI on a remote device. The UI can be configured to display topography maps, such as described above, flow maps, a heat map as a matrix of flows and paths, UI objects, such as graphs, and recommendations including actions that can be implemented by the user.

In 1818, user selection of an action may be received via the UI. In 1820, the system can translate actions selected via the interface to device level instructions to one or more specific devices in the cloud. In 1822, the system can communicate with one or more specific devices to implement the device level instructions. In 1824, the system can log actions and states of the cloud resources, such as before and after the action.

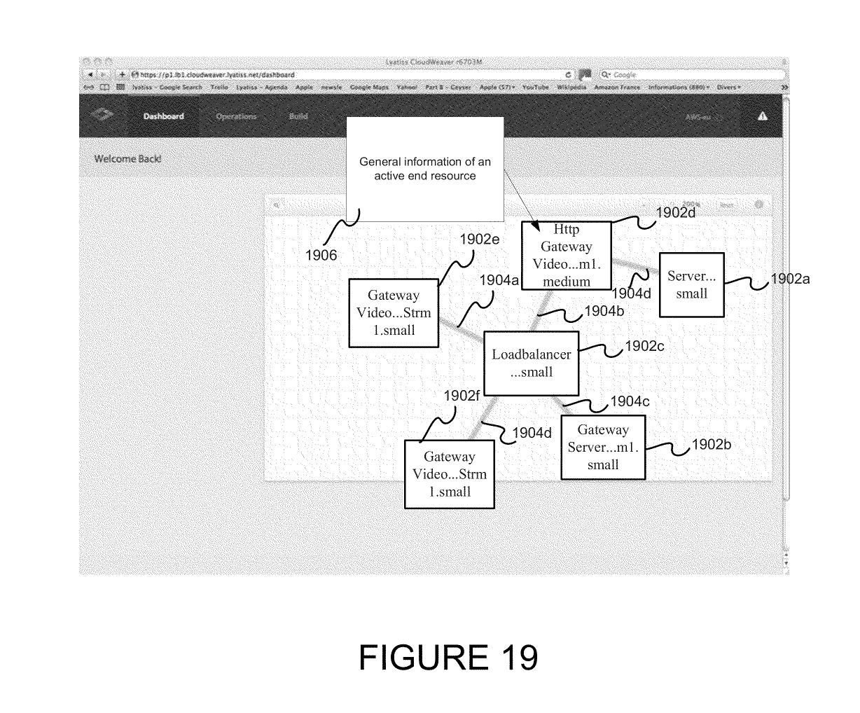

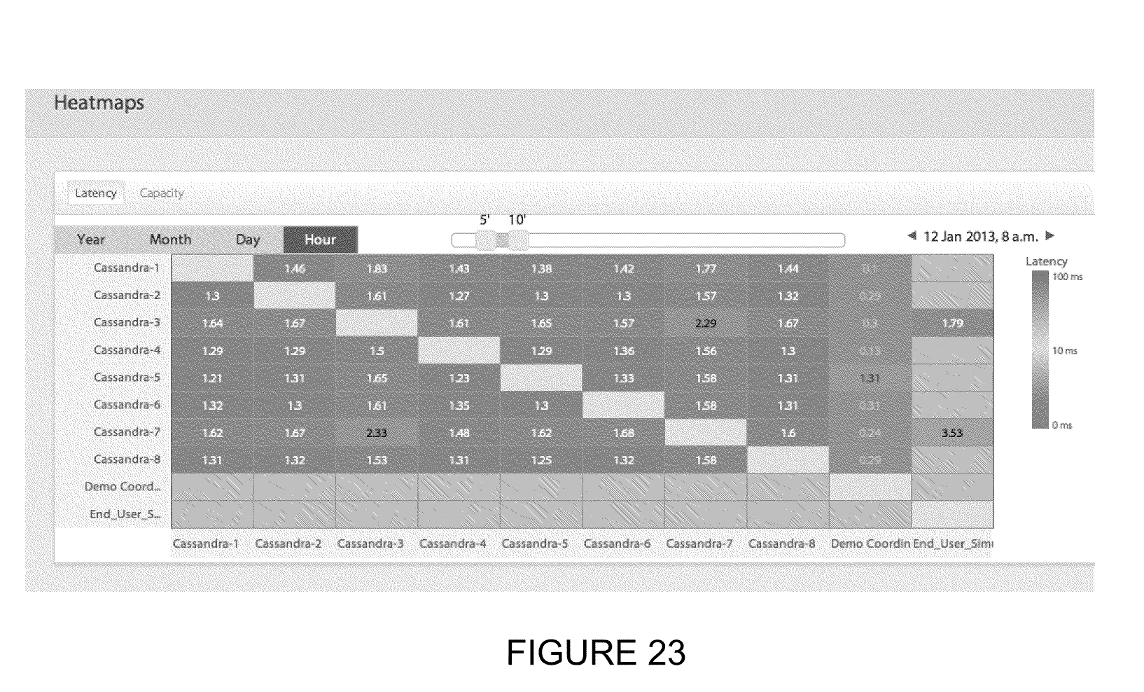

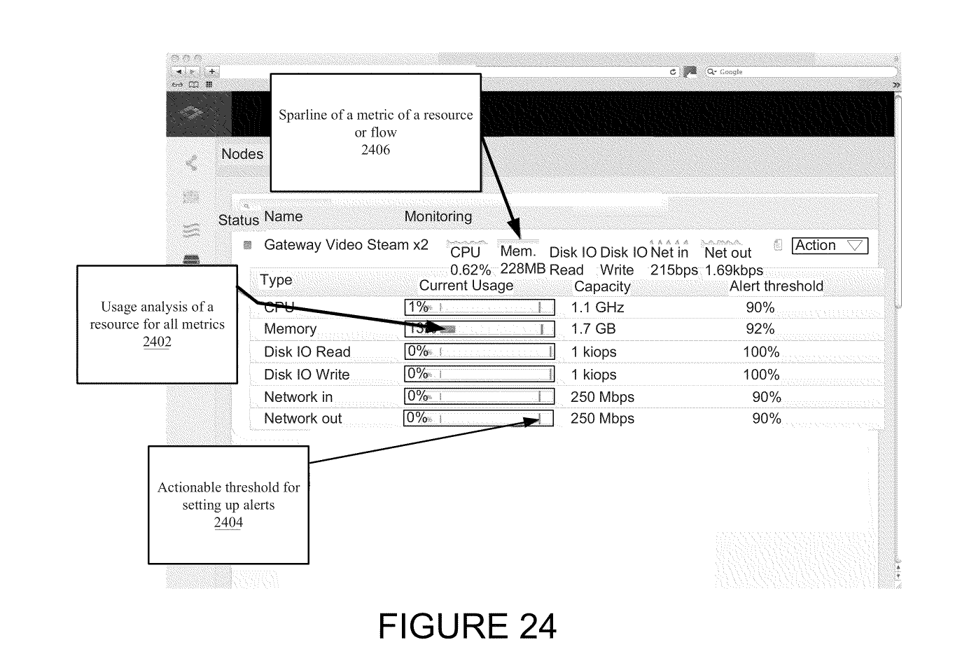

Next, a few screen shots from a UI including an actionable flow map are described with respect to FIGS. 19, 20, 21, 22. In FIG. 23, another representation of the application topology is given in the form of an actionable matrix. This actionable matrix shows simultaneously the flow performance and the network performance of the non-active paths. Each cell of the matrix can be actionable such an interaction with the object in the UI can cause a generation of a new UI state that provides the user with the performance detail of flows and paths (FIG. 24). In FIG. 24, a detailed resource usage analysis associated with the flow map and the heat map (or actionable matrix) is discussed.

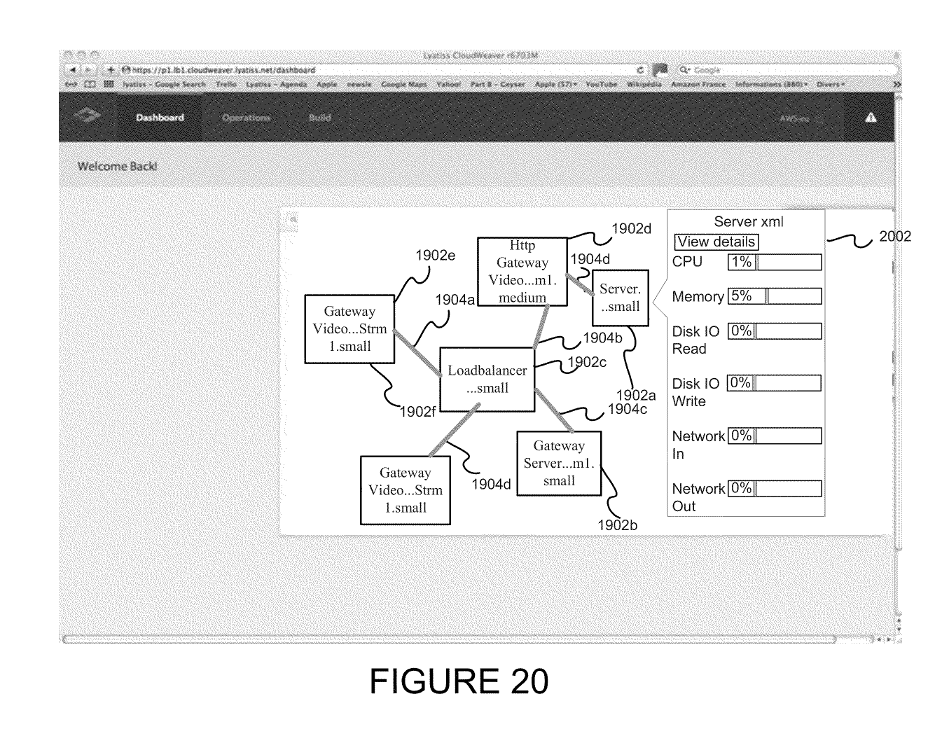

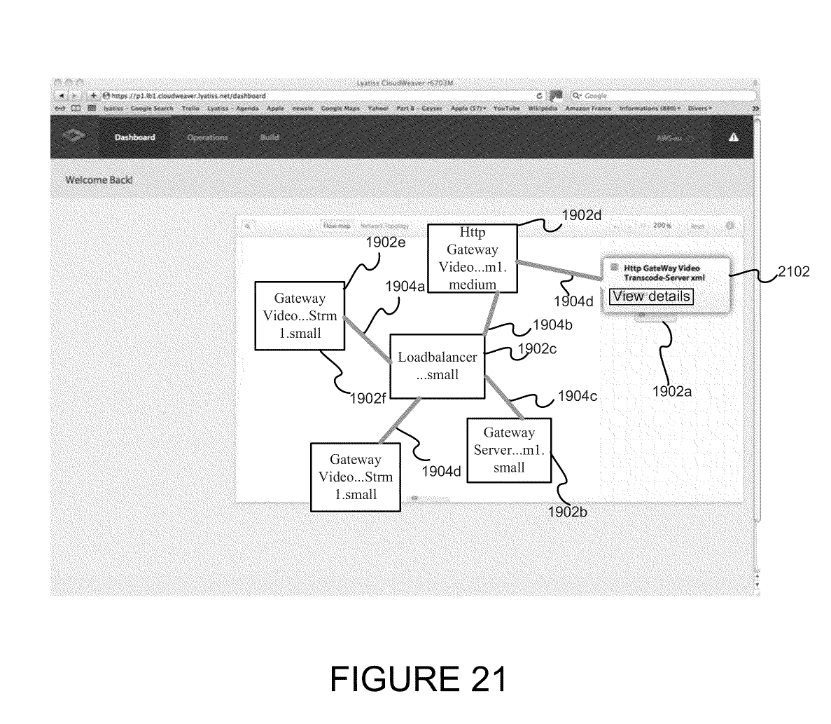

In FIG. 19, a flow map including 6 nodes (e.g., 1902a-f), which are end resources, and five flows (e.g., 1904a-d) are shown. General information 1906 (such as resource designation and IP addresses) for each active end resource can be displayed. In FIG. 20, a user has interacted with the UI to display a usage analysis 2002 for an active end resource (1902a). In FIG. 21, a user has interacted with the UI to display a usage analysis 2102 of an active flow (1904d). From this flow map, the user can trigger an interface state that allows a direct change to the setup of usage alerts associated with the flow's metrics.

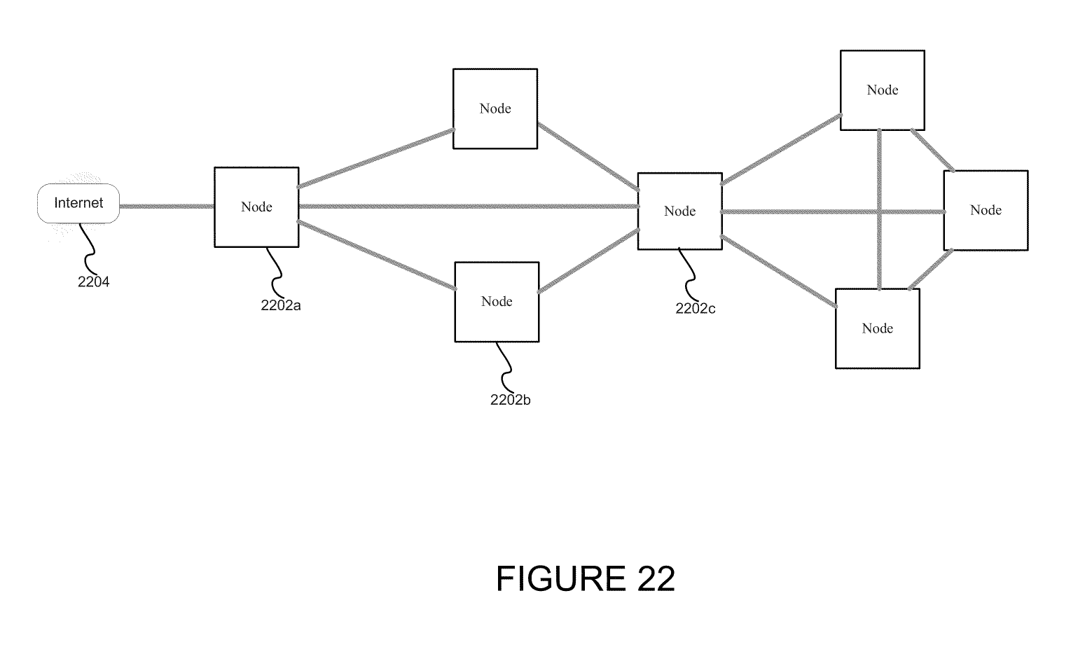

In FIG. 22, an automatically structured flow map is proposed. The structure integrates the Internet node 2204 and displays the different tiers of the application in order. The node 2202a connected to the Internet and being the only node directly accessed from the Internet, while the other nodes (e.g., 2202b and 2202c) are connected indirectly through node 2202a.

In FIG. 23, another representation of the application topology is proposed. This is the representation of a graph by a matrix. In this matrix, each cell is active, such that a selection of the cell redirects the user to detailed performance information. After selection, the detailed information can be displayed in a pop up window or the UI can generate another page that displays the information.

In FIG. 24, a more detailed usage analysis associated with the flow map is displayed. In one embodiment, the usage analysis includes a sparkline of a metric (2406). The sparkline can be associated with a metric that characterizes a flow or a resource. Graphs representing the states of other metrics are also shown. In addition, usage analysis for all of the metrics (e.g., 2402) is shown. The system allows a user to input actionable thresholds (e.g., 2404). The actionable thresholds are represented as lines in FIG. 24.

In a particular embodiment, the system can be configured to generate alerts when one or a combination of the thresholds is exceeded. The alerts can results in instantaneous color modification in the UI. Other visual indicators can be employed. For example, objects can blink or change in brightness to attract a user's attention. In another embodiment, an auditory cue can be generated. In yet another embodiment, the system can send out a message to a user, such as an e-mail or text, which alerts the user of the event.

Although the foregoing invention has been described in some detail for purposes of clarity of understanding, it will be apparent that certain changes and modifications may be practiced within the scope of the appended claims. It should be noted that there are many alternative ways of implementing the processes, systems, and apparatus of the present invention. Accordingly, the present embodiments are to be considered as illustrative and not restrictive, and the invention is not to be limited to the details given herein.

What is claimed is:

1. A method in an electronic device including a processor and a memory, the method comprising:
in the processor, receiving cloud or distributed resource access credentials for a user;
in the processor, collecting cloud or distributed resource data using a native resource interface;
in the processor, extracting topology data from the cloud or distributed resource data, wherein the topology data describes virtual resources of the user in a cloud or distributed resource configuration;
based upon the topology data, generating a network topology map in the processor;
in the processor, controlling output of a User Interface (UI) including the network topology map, wherein the UI includes a plurality of user selectable actions for affecting the virtual resources;
in the processor, receiving a selection of a first action;
translating the action into a series of device level instructions in accordance with requirements of the cloud or distributed resource; and
the processor communicating with one or more specific virtual resources of the user to implement the device level instructions.

2. The method of claim 1, further comprising deploying monitoring software to one or more virtual or physical devices associated with the user's virtual resources, wherein at least a portion of the cloud or distributed resource data is collected via the monitoring software.

3. The method of claim 2, further comprising
based upon the cloud or distributed resource data, determining nodes and flows associated with the user's virtual resources;
generating a flow map that includes a plurality of actionable node or flow objects representing the flows and nodes; and
in the processor, controlling output to the UI of the flow map, which includes actionable node and flow objects, which when each is selected cause additional information pertaining to the selected actionable node or flow object's corresponding node or flow to be output to the UI or cause performance of an action for managing the selected actionable node or the flow object's corresponding virtual resource.

4. The method of claim 3, further comprising receiving a selection of a first one of the one or more actionable node or flow objects and, in response to such selection, displaying the additional information pertaining to the corresponding node or flow.

5. The method of claim 4, wherein each flow represents usage of the user's cloud or distributed configuration between two or more of the nodes, and wherein selection of a first flow object is received, and wherein the displayed additional information includes one or more congestion or bottleneck metrics about the first flow object's corresponding flow.

6. The method of claim 3, wherein the displayed additional information in the UI indicates performance metrics of the selected actionable node or flow object's corresponding virtual resource and the displayed additional information has a selectable mechanism for the user to change a setup of one or more performance alerts for the selected actionable node or flow object's corresponding virtual resource.

7. The method of claim 3, wherein the flow map, which is displayed in the UI, includes indications of whether each actionable node and flow object's corresponding virtual resource has a congestion or capacity level that has exceeded a predetermined threshold value.

8. The method of claim 1, wherein the network topology map of the UI is hierarchical and includes a representation of the Internet as a root of one or more regional and/or sub-regional networks that each includes one or more of the user's virtual resources.

9. The method of claim 8, wherein the network topology map specifies whether each regional and/or sub-regional network and virtual resource is manageable or non-manageable via the UI.

10. The method of claim 1, wherein the first action specifies that a selected one of the user's virtual resources is to move from a first group of virtual resources to a second group of virtual resources.

11. The method of claim 1, wherein the first action specifies adding a network service.

12. The method of claim 1, wherein the first action specifies filtering the user's virtual resources for display in the network topology map.

13. An apparatus for cloud or distributed computing resource management, the apparatus formed from one or more electronic devices that are configured to perform the following operations:
receiving cloud or distributed resource access credentials for a user;
collecting cloud or distributed resource data using a native resource interface;
extracting topology data from the cloud or distributed resource data, wherein the topology data describes virtual resources of the user in a cloud or distributed resource configuration;
based upon the topology data, generating a network topology map in the processor;
controlling output of a User Interface (UI) including the network topology map, wherein the UI includes a plurality of user selectable actions for affecting the virtual resources;
receiving a selection of a first action;
translating the action into a series of device level instructions in accordance with requirements of the cloud or distributed resource; and
communicating with one or more specific virtual resources of the user to implement the device level instructions.

14. The apparatus of claim 13, further comprising deploying monitoring software to one or more virtual or physical devices associated with the user's virtual resources, wherein at least a portion of the cloud or distributed resource data is collected via the monitoring software.

15. The apparatus of claim 14, further comprising
based upon the cloud or distributed resource data, determining nodes and flows associated with the user's virtual resources;
generating a flow map that includes a plurality of actionable node or flow objects representing the flows and nodes; and
in the processor, controlling output to the UI of the flow map, which includes actionable node and flow objects, which when each is selected cause additional information pertaining to the selected actionable node or flow object's corresponding node or flow to be output to the UI or cause performance of an action for managing the selected actionable node or the flow object's corresponding virtual resource.

16. The apparatus of claim 15, further comprising receiving a selection of a first one of the one or more actionable node or flow objects and, in response to such selection, displaying the additional information pertaining to the corresponding node or flow.

17. The apparatus of claim 16, wherein each flow represents usage of the user's cloud or distributed configuration between two or more of the nodes, and wherein selection of a first flow object is received, and wherein the displayed additional information includes one or more congestion or bottleneck metrics about the first flow object's corresponding flow.

18. The apparatus of claim 15, wherein the displayed additional information in the UI indicates performance metrics of the selected actionable node or flow object's corresponding virtual resource and the displayed additional information has a selectable mechanism for the user to change a setup of one or more performance alerts for the selected actionable node or flow object's corresponding virtual resource.

19. The apparatus of claim 15, wherein the flow map, which is displayed in the UI, includes indications of whether each actionable node and flow object's corresponding virtual resource has a congestion or capacity level that has exceeded a predetermined threshold value.

20. The apparatus of claim 13, wherein the network topology map of the UI is hierarchical and includes a representation of the Internet as a root of one or more regional and/or sub-regional networks that each includes one or more of the user's virtual resources.

21. The apparatus of claim 20, wherein the network topology map specifies whether each regional and/or sub-regional network and virtual resource is manageable or non-manageable via the UI.

22. The apparatus of claim 13, wherein the first action specifies that a selected one of the user's virtual resources is to move from a first group of virtual resources to a second group of virtual resources.

23. The apparatus of claim 13, wherein the first action specifies adding a network service.

24. The apparatus of claim 13, wherein the first action specifies filtering the user's virtual resources for display in the network topology map.

25. At least one computer readable storage medium having computer program instructions stored thereon that are arranged to perform the following operations:
receiving cloud or distributed resource access credentials for a user;
collecting cloud or distributed resource data using a native resource interface;
extracting topology data from the cloud or distributed resource data, wherein the topology data describes virtual resources of the user in a cloud or distributed resource configuration;
based upon the topology data, generating a network topology map in the processor;
controlling output of a User Interface (UI) including the network topology map, wherein the UI includes a plurality of user selectable actions for affecting the virtual resources;
receiving a selection of a first action;
translating the action into a series of device level instructions in accordance with requirements of the cloud or distributed resource; and
communicating with one or more specific virtual resources of the user to implement the device level instructions.
